(19) United States
(12) Patent Application Publication
(10) Pub. No.: US 2014/0339329 A1
(43) Pub. Date: Nov. 20, 2014

(54) PAINT SPRAYER

(71) Applicant: Campbell Hausfeld / Scott Fetzer Company, Harrison, OH (US)

(72) Inventors: Bobby Lynn Lawrence, Palmetto, FL (US); Douglas R. Harper, Harrison, OH (US)

(21) Appl. No.: 14/365,384

(22) PCT Filed: Dec. 19, 2012
(86) PCT No.: PCT/US2012/070527

§ 371 Date: Jun. 13, 2014

Related U.S. Application Data
(60) Provisional application No. 61/583,022, filed on Jan. 4, 2012.

(30) Foreign Application Priority Data
Dec. 20, 2011 (US) 13330893

(51) Int. Cl. B05B 7/32; B05B 7/24; B05B 15/04

(52) U.S. Cl. CPC B05B 7/32; B05B 15/0406; B05B 7/2491
USPC 239/127; 239/373

(57) ABSTRACT

According to one embodiment, an apparatus comprises a paint container, a paint sprayer assembly, movable grip members, and a ring. The paint container has an outer diameter. The paint sprayer assembly includes a housing having an air inlet and a nozzle located on the housing. The movable grip members are supported on the housing in a circular array having an inner diameter greater than the outer diameter of the paint container. The ring extends circumferentially about the circular array of grip members. The ring is supported on the housing for rotation relative to the housing, and is configured to move the grip members to a condition in which the inner diameter of the circular array is not greater than the outer diameter of the paint container upon rotation of the ring relative to the housing.

### CROSS REFERENCE TO RELATED APPLICATIONS

This application is a continuation-in-part of U.S. Non-provisional patent application Ser. No. 13/330,893, “Paint Sprayer with Paint Container Attachment Apparatus”, filed Dec. 20, 2011, which is hereby expressly incorporated by reference herein in its entirety. This application also claims the priority benefit of U.S. Provisional Patent Application Ser. No. 61/583,022, “Paint Sprayer”, filed Jan. 4, 2012, which is hereby expressly incorporated by reference herein in its entirety.

### TECHNICAL FIELD

This application relates generally to devices to facilitate spraying of paint.

### BACKGROUND

A sprayer for paint has a nozzle and a trigger. A container of paint is mounted on the sprayer. When a user depresses the trigger, paint is sprayed outward from the nozzle.

### SUMMARY

According to one embodiment, an apparatus comprises a paint container, a paint sprayer assembly, movable grip members, and a ring. The paint container has an outer diameter. The paint sprayer assembly includes a housing having an air inlet and a nozzle located on the housing. The movable grip members are supported on the housing in a circular array having an inner diameter greater than the outer diameter of the paint container. The ring extends circumferentially about the circular array of grip members. The ring is supported on the housing for rotation relative to the housing, and is configured to move the grip members to a condition in which the inner diameter of the circular array is not greater than the outer diameter of the paint container upon rotation of the ring relative to the housing.

According to another embodiment, an apparatus comprises a paint container, a paint sprayer assembly, grip members, and a ring. The paint container has a cylindrical outer surface. The paint sprayer assembly includes a housing having an air inlet and a nozzle located on the housing. The grip members are supported on the housing in a circular array configured to surround the cylindrical outer surface of the paint container. The ring extends circumferentially about the circular array of grip members. The ring is supported on the housing for rotation relative to the housing, and is configured to press the grip members radially inward against the cylindrical outer surface of the paint container upon rotating relative to the housing.

According to yet another embodiment, an apparatus comprises an open can of paint, a paint sprayer assembly, grip members, and a ring. The open can of paint has a cylindrical outer surface and an inner rim with a sealing groove configured to receive a sealing bead on a paint can lid. The paint sprayer assembly includes a housing having an air inlet and a nozzle located on the housing. The grip members are supported on the housing in a circular array surrounding the cylindrical outer surface of the open can of paint. The ring extends circumferentially about the circular array of grip members. The ring is supported on the housing for rotation relative to the housing, and is configured to press the grip members radially inward against the cylindrical outer surface of the open can of paint upon rotating relative to the housing.

According to still another embodiment, an apparatus comprises a paint container, a paint sprayer assembly, and a pair of concentric rings. The paint container has an outer diameter. The paint sprayer assembly includes a housing having an air inlet and a nozzle located on the housing. The pair of concentric rings is supported on the housing for rotation relative to each other. One of the rings has a circular array of deflectable grip members in unstressed conditions in which the circular array has an inner diameter greater than the outer diameter of the paint container. The other of the rings has cams configured to deflect the grip members from the unstressed conditions to stressed conditions in which the inner diameter of the circular array is not greater than the outer diameter of the paint container upon rotation of the rings relative to each other.

According to yet another embodiment, an apparatus comprises a paint container, a paint sprayer assembly, a first ring, and a second ring. The paint container has a cylindrical outer surface. The paint sprayer assembly includes a housing having an air inlet and a nozzle located on the housing. The first ring is supported on the housing. The first ring has grip members and is configured to receive the paint container in an installed position in which the grip members face radially inward toward the cylindrical outer surface of the paint container. The second ring is supported on the housing for rotation relative to the first ring. The second ring has cams configured to press the grip members radially inward against the cylindrical outer surface of the paint container upon rotation of the second ring relative to the first ring when the paint container is in the installed position.

According to yet another embodiment, a paint sprayer assembly comprises a housing, a paint container, a nozzle, an air inlet, a paint siphon line, and an air motor assembly. The housing defines an air motor compartment. The paint container is configured for selective coupling with the housing. The nozzle is supported by the housing. The air inlet is supported by the housing. The air motor assembly is disposed at least partially within the air motor compartment. The air motor assembly comprises an air motor and a paint pump coupled with the air motor. The air motor is coupled with the air inlet and defines an exhaust air vent hole. The paint pump is coupled with the nozzle and the paint siphon line. The paint pump is in fluid communication with the nozzle and the paint siphon line such that the paint pump is configured to siphon paint from the paint container, through the paint siphon line, and outward through the nozzle. The housing defines an air flow path extending from the exhaust air vent hole to the paint container, to facilitate pressurization of the paint container by air exhausted by the air motor.

According to still another embodiment, an apparatus comprises a paint container and a paint pump. The paint pump has a pump piston supported for reciprocation in a paint flow space. The apparatus further comprises a paint siphon line and a paint return line communicating the paint container with the paint flow space. The apparatus further comprises an air motor and seal means. The air motor has a motor piston that is supported for reciprocation in a pressurized air chamber. The motor piston is coupled with the pump piston. The seal means blocks paint from flowing from the paint flow space to the pressurized air chamber, and allows air to flow from the pressurized air chamber to the paint flow space.

According to yet another embodiment, an apparatus comprises a paint container and a paint pump. The paint pump has a pump piston supported for reciprocation in a paint flow space. The apparatus further comprises a paint siphon line and a paint return line communicating the paint container with the paint flow space. The apparatus further comprises an air motor and a piston seal. The air motor has a motor piston that is supported for reciprocation in a pressurized air chamber. The motor piston is coupled with the pump piston. The piston seal comprises a washer-shaped structure having a first planar side surface exposed to the paint flow space, a second planar side surface exposed to the pressurized air chamber, and an annular inner surface in sliding engagement with the pump piston.

According to another embodiment, an apparatus comprises a paint container and a paint pump. The paint pump has a pump piston supported for reciprocation in a paint flow space. The apparatus further comprises a paint siphon line and a paint return line communicating the paint container with the paint flow space. The apparatus further comprises an air motor and a piston seal. The air motor has a motor piston that is supported for reciprocation in a pressurized air chamber. The motor piston is coupled with the pump piston. The piston seal has a first side exposed to the paint flow space, a second side exposed to the pressurized air chamber, and an annular inner surface in sliding engagement with the pump piston. The pump piston has a peripheral air flow recess that adjoins the annular inner surface of the piston seal when the pump piston is in a terminal forward stroke position.

According to still another embodiment, a nozzle assembly for a paint sprayer comprises an inlet structure and a lever. The inlet structure defines a fluid entry passageway. The lever is movable among at least a first position and a second position. The lever comprises a finger interface portion and a valve portion. The valve portion defines a first aperture and a second aperture. The first aperture is aligned and in fluid communication with the fluid entry passageway when the lever is in the first position. The second aperture is aligned and in fluid communication with the fluid entry passageway when the lever is in the second position. The first aperture is different than the second aperture with respect to at least one of size and shape.

According to yet another embodiment, a paint sprayer comprises a housing and a nozzle assembly. The housing is configured for removable coupling to a paint container. The nozzle assembly is coupled with the housing. The nozzle assembly comprises an inlet structure and a lever. The inlet structure defines a fluid entry passageway. The lever is movable among at least a first position and a second position. The lever comprises a finger interface portion and a valve portion. The valve portion defines a first aperture and a second aperture. The first aperture is aligned and in fluid communication with the fluid entry passageway when the lever is in the first position. The second aperture is aligned and in fluid communication with the fluid entry passageway when the lever is in the second position. The first aperture is different than the second aperture with respect to at least one of size and shape.

According to another embodiment, a paint sprayer comprises a housing, an air inlet, an air motor assembly, a trigger, a paint siphon line, and a nozzle. The housing defines an air motor compartment, a pistol grip handle, and a paint container coupling portion. The air inlet is supported by the housing. The air motor assembly is disposed at least partially within the air motor compartment. The air motor assembly comprises an air motor and a paint pump coupled with the air motor. The trigger is supported by the pistol grip handle and is configured to facilitate selective fluid communication between the air inlet and the air motor. The paint siphon line extends through the pistol grip handle and in fluid communication with each of the paint container coupling portion and the paint pump. The nozzle is supported by the housing and is in fluid communication with the paint pump.

### BRIEF DESCRIPTION OF THE DRAWINGS

Various embodiments will become better understood with regard to the following description, appended claims and accompanying drawings wherein:

FIG. 1 is a side view of a paint sprayer with an attached paint container, in accordance with one embodiment;

FIG. 2 is an exploded view of parts shown in FIG. 1;

FIG. 3 is a lower perspective view of a part shown in FIG. 2;

FIG. 4 is a lower perspective view of another part shown in FIG. 2;

FIG. 5 is a top view of a part shown in FIG. 2;

FIG. 6 is a bottom view of the part shown in FIG. 5;

FIG. 7 is a sectional view taken in line 7-7 of FIG. 6;

FIG. 8 is a top view of another part shown in FIG. 2;

FIG. 9 is a bottom view of the part shown in FIG. 8;

FIG. 10 is a view similar to FIG. 9, showing an additional part;

FIG. 11 is a lower perspective view of the part shown in FIGS. 8 and 9;

FIG. 12 is a partial view of the parts shown in FIGS. 6 and 9;

FIG. 13 is a perspective view of the paint container shown in FIG. 1;

FIGS. 14-15 are partial sectional views of a paint can and a paint can lid;

FIG. 16 is an upper perspective view of a part of a second embodiment of a paint sprayer;

FIGS. 17-18 are lower perspective views of parts of the second embodiment;

FIGS. 19-20 are upper and lower perspective views of a part of a third embodiment of a paint sprayer;

FIGS. 21-22 are upper and lower perspective views of a part of the third embodiment;

FIGS. 23-24 are side perspective views of other parts of the third embodiment;

FIG. 25 is a partial sectional view of parts of the third embodiment;

FIG. 26 is a side perspective view of parts of the third embodiment, with an air motor assembly shown generally schematically;

FIGS. 27-28 are side sectional views of parts of the paint sprayer of FIG. 26, shown schematically in part;

FIG. 29 is an enlarged view of parts shown in FIGS. 27-28;

FIG. 30 is a view similar to FIG. 29, showing parts of an alternative embodiment of a paint sprayer;

FIG. 31 is a top plan view depicting a portion of a paint sprayer;

FIG. 32 is a front elevational view depicting a portion of the paint sprayer of FIG. 31, but wherein a portion of a nozzle assembly has been removed;

FIG. 33 is a plan view generally schematically depicting a lever of the nozzle assembly of FIG. 32;

FIG. 34 is a cross-sectional view taken along lines 34-34 in FIG. 33;

FIG. 35 is side sectional view of parts of a paint sprayer similar to that of

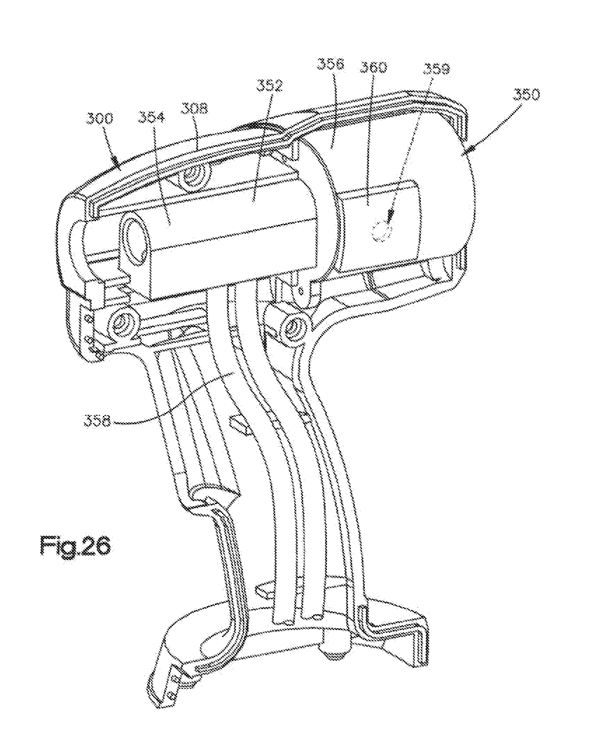

FIG. 26, with a motor piston shown in a rearward position;

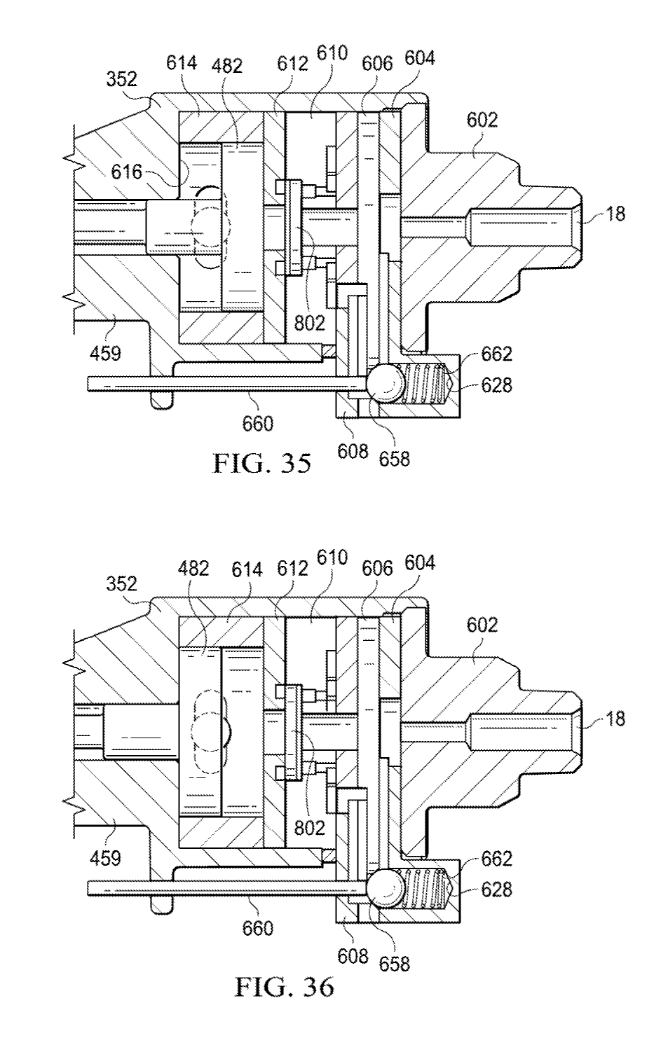

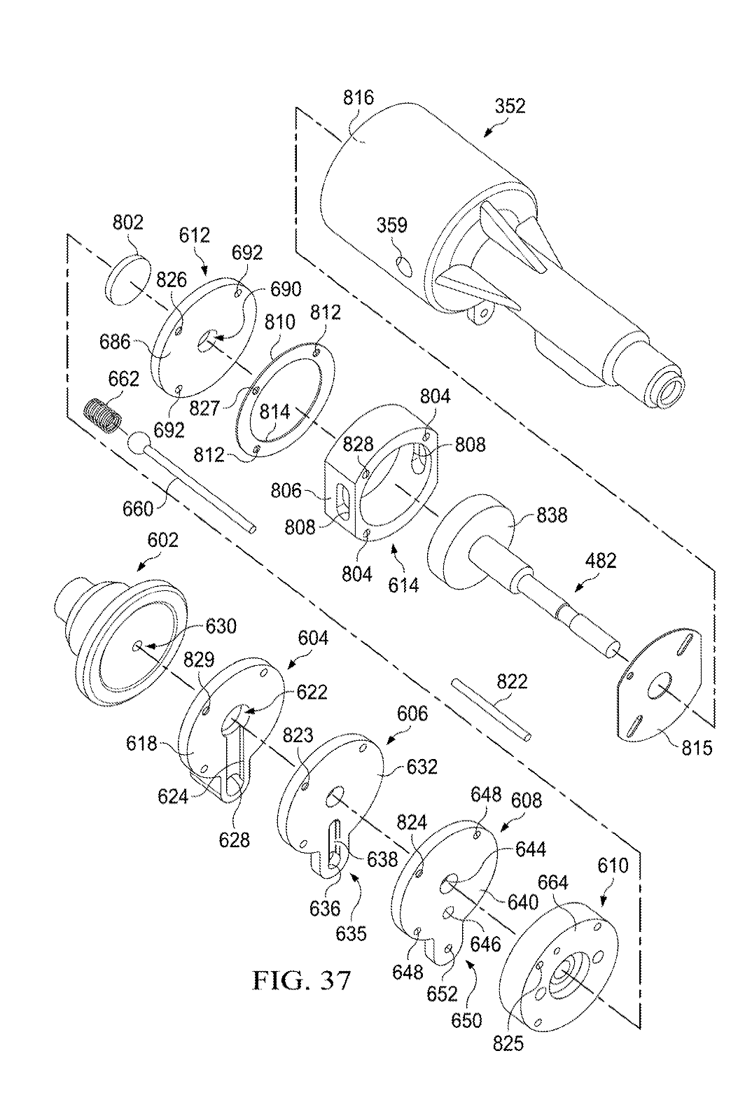

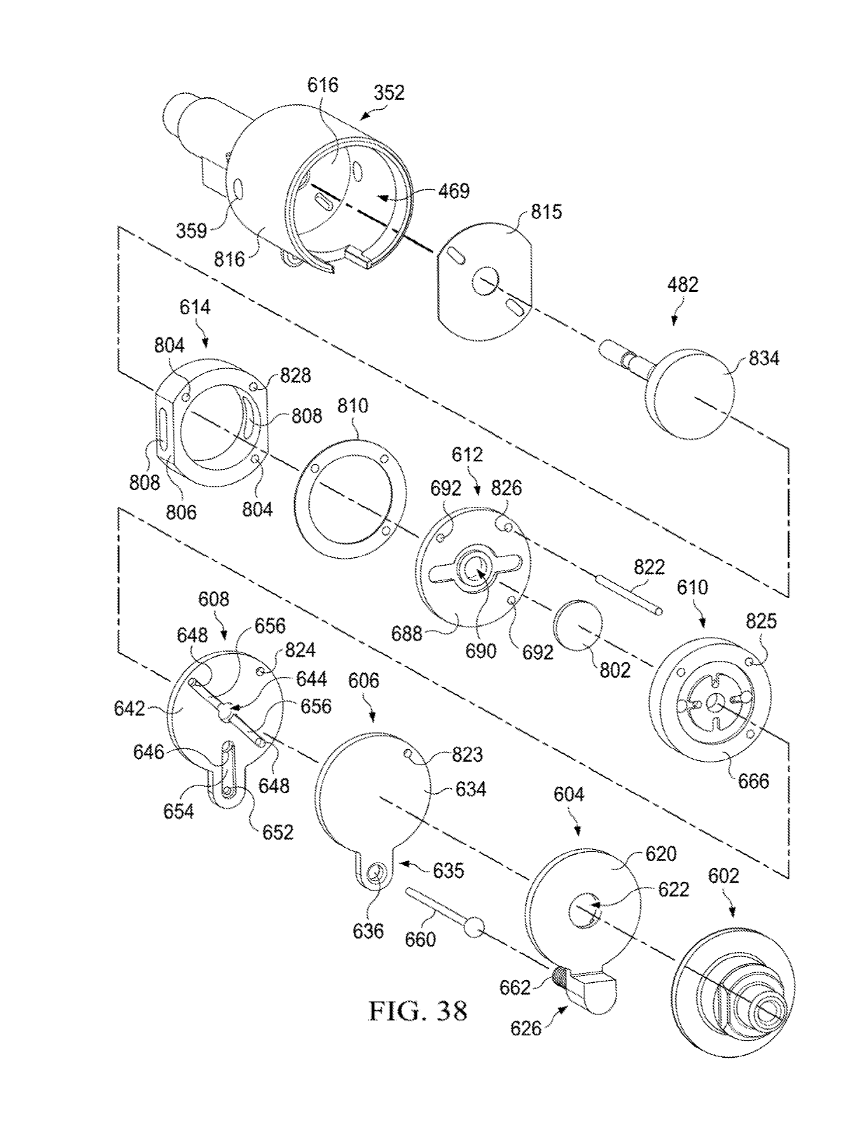

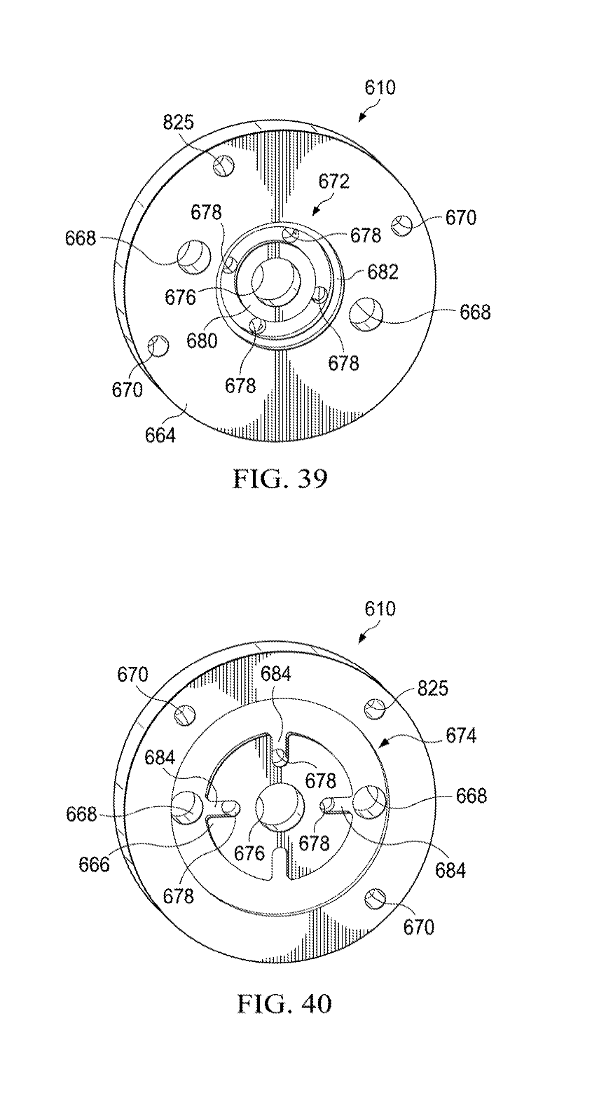

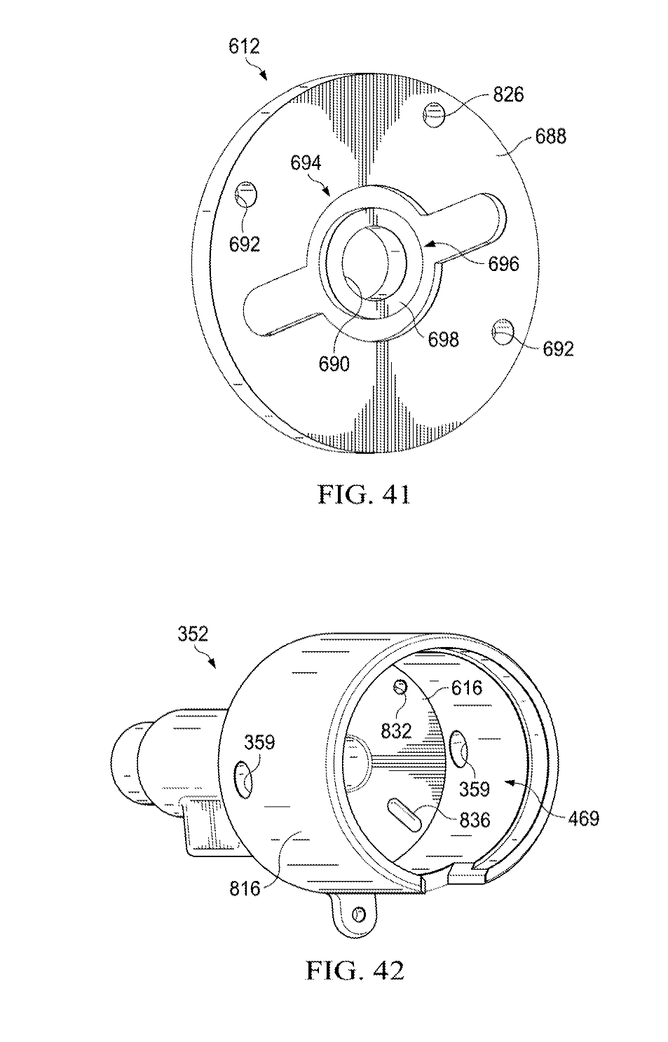

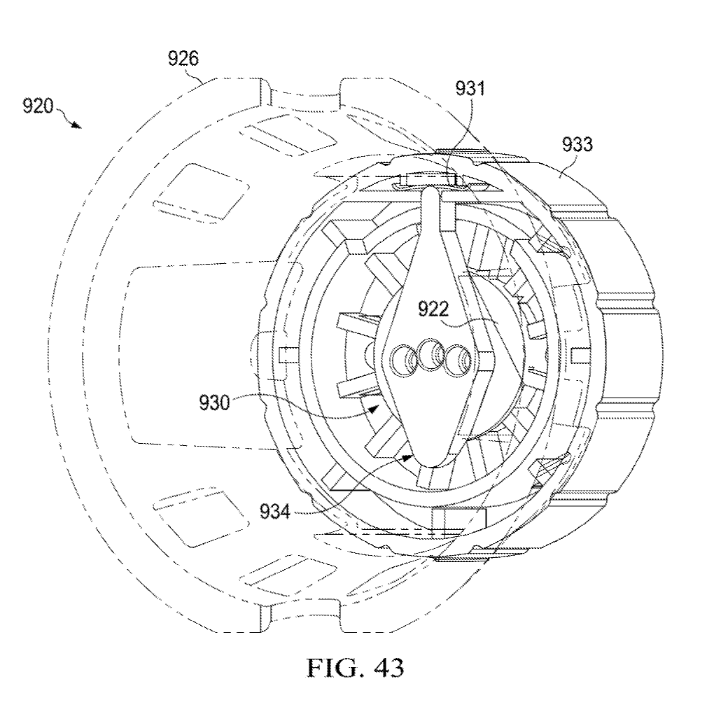

FIG. 36 is a side sectional view similar to FIG. 35, but with the motor piston shown in a forward position;

FIG. 37 is an exploded front perspective view depicting the parts of FIG. 35;

FIG. 38 is an exploded rear perspective view depicting the parts of FIG. 35;

FIG. 39 is an enlarged front perspective view depicting one of the parts of FIG. 37;

FIG. 40 is a rear perspective view depicting the part of FIG. 39;

FIG. 41 is an enlarged rear perspective view depicting another one of the parts of FIG. 37;

FIG. 42 is an enlarged rear perspective view depicting yet another one of the parts of FIG. 37; and

FIG. 43 is a perspective view depicting a nozzle assembly for a paint sprayer in accordance with another embodiment, wherein an outline of a spray head portion of the nozzle assembly is shown in dashed lines.

### DETAILED DESCRIPTION

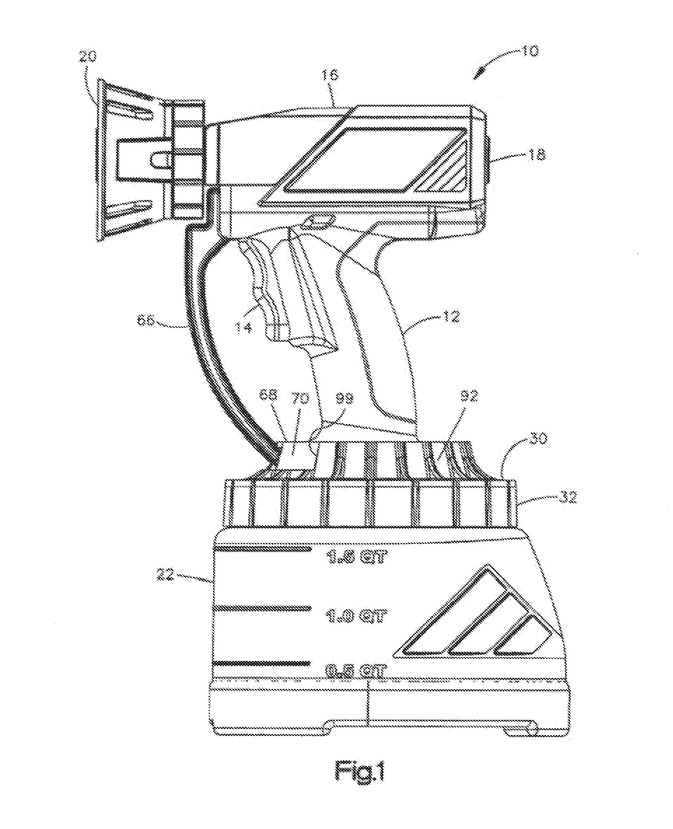

A paint sprayer 10 is shown in FIG. 1. In this embodiment, the paint sprayer 10 is a handheld device with a handle 12 and a trigger 14. The handle 12 is shown to be configured as a pistol grip handle, and is part of an outer housing or housing 16. The trigger 14 is shown to be supported by the handle 12. The housing 16 can contain an air motor (described below) that receives pressurized air from a hose connected to an air inlet port 18 at the rear end of the housing 16. A nozzle 20 is located and supported by the housing 16 at the front end of the housing 16. A paint container 22 is mounted or supported on the housing 16 at the lower end of the handle 12. The housing 16 also contains a fluid or paint pump (described below) that is driven by the air motor to prime and spray paint from the container 22 outward through the nozzle 20.

The paint sprayer 10 can include a paint container coupling portion. In one embodiment, the paint container coupling portion can comprise upper and lower rings 30 and 32 supported on the housing 16 at the lower end of the handle 12. The rings 30 and 32 cooperate with the housing 16 such that rotating the rings 30 and 32 relative to each other in a first direction grips and secures the paint container 22 to the housing 16, and rotating the rings 30 and 32 relative to each other in the opposite direction releases the paint container 22 from the housing 16.

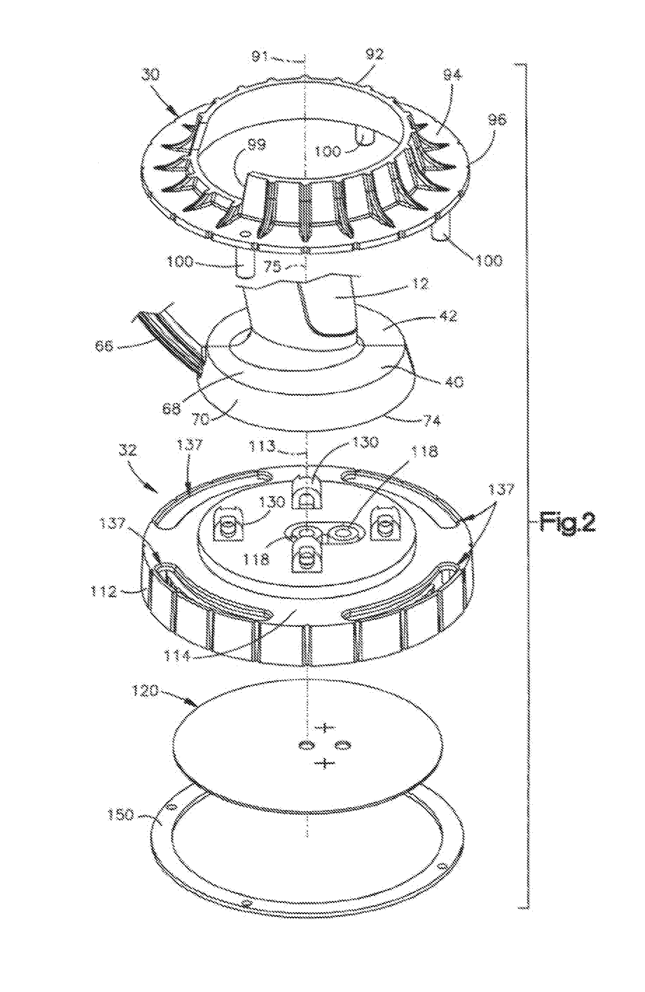

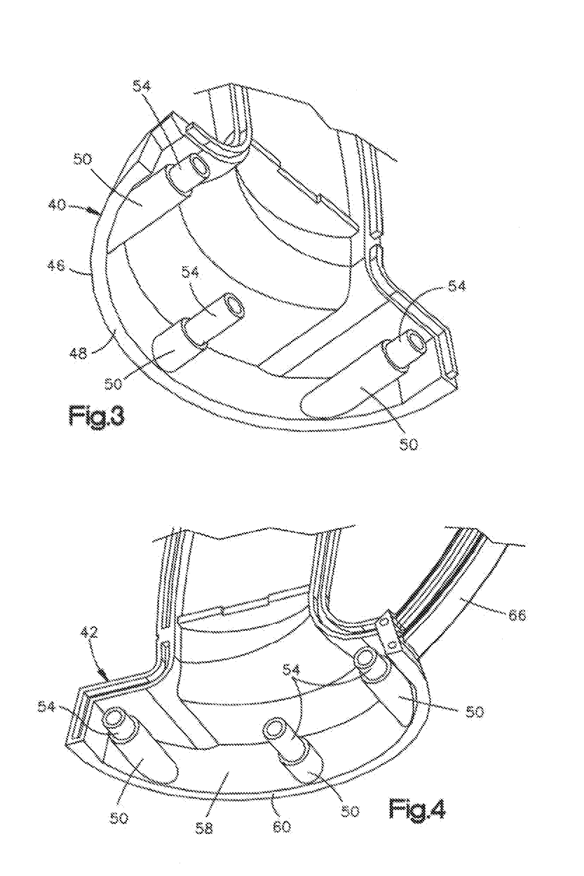

As shown partially in FIG. 2, the handle 12 has right and left side parts 40 and 42. As viewed from below in FIG. 3, the right side part 40 has a semi-circular wall 46 with a bottom edge 48. Three cylindrical pegs 50 project from the wall 46 across the inside of the handle 12. Each peg 50 has an outer end portion 54 with a reduced diameter. As viewed from below in FIG. 4, the left side part 42 also has a semi-circular wall 58 with a bottom edge 60 and three cylindrical pegs 50 projecting across the inside of the handle 12. Each of those pegs 50 also has a lesser diameter outer end portion 54. The left side part 42 of the handle 12 further includes a trigger guard 66.

When the two side parts 40 and 42 are joined together as shown in FIG. 2, they define a short, cylindrical base portion 68 of the handle 12 with a tapered side surface 70. The bottom edges 48 and 60 (FIGS. 3 and 4) together define a circular, open lower end 74 of the handle 12 which is centered on a vertical axis 75.

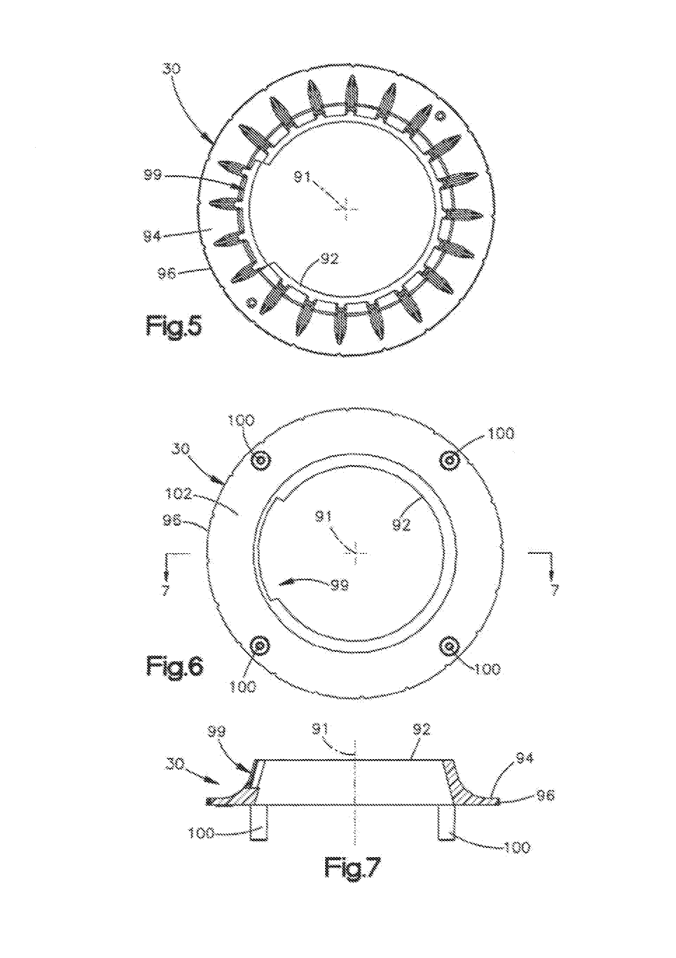

As shown separately in FIGS. 5-7, the upper ring 30 has a circular shape centered on an axis 91. A cylindrical wall portion 92 of the upper ring 30 is located at the upper side 94 of a flat annular flange portion 96. The wall 92 tapers radially inward as it projects upward from the flange 96. A cutout 99 for the trigger guard 66 extends partly around the circumference of the wall 92. Four cams 100 are located at the lower side 102 of the flange 96. In the preferred embodiment, the cams 100 are configured as posts that project axially downward from the lower side 102 of the flange 96 at locations that are equally spaced apart in a circular array centered on the axis 91.

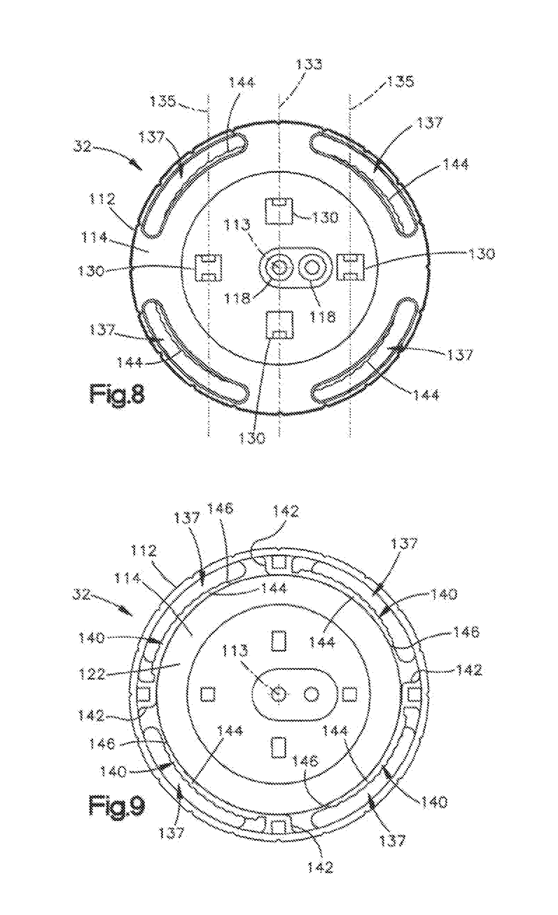

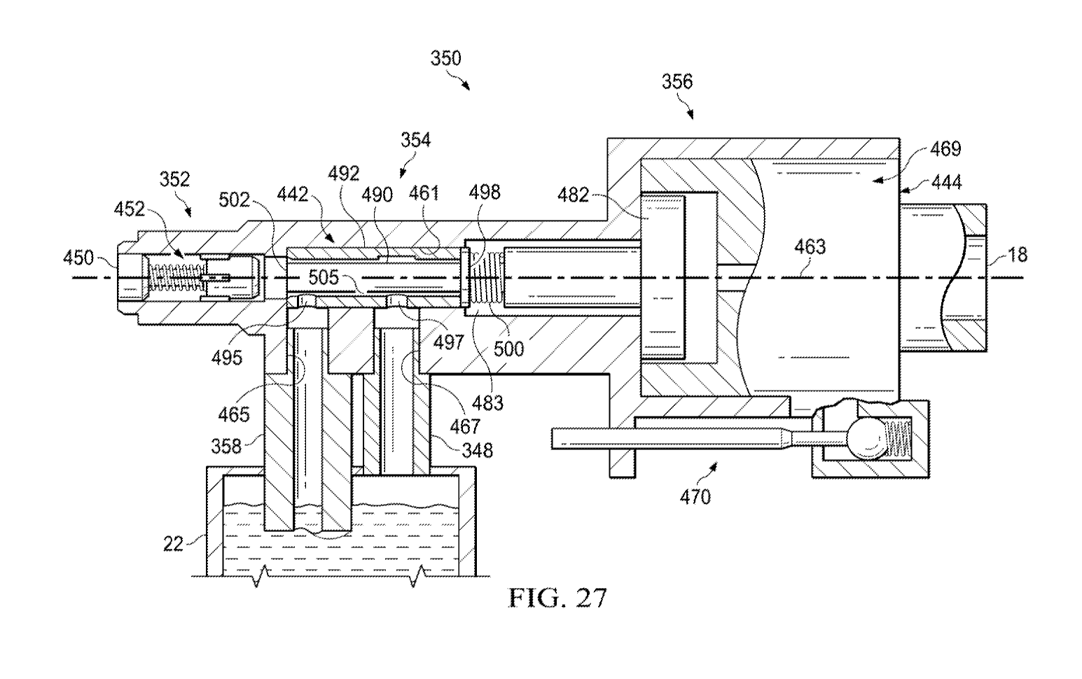

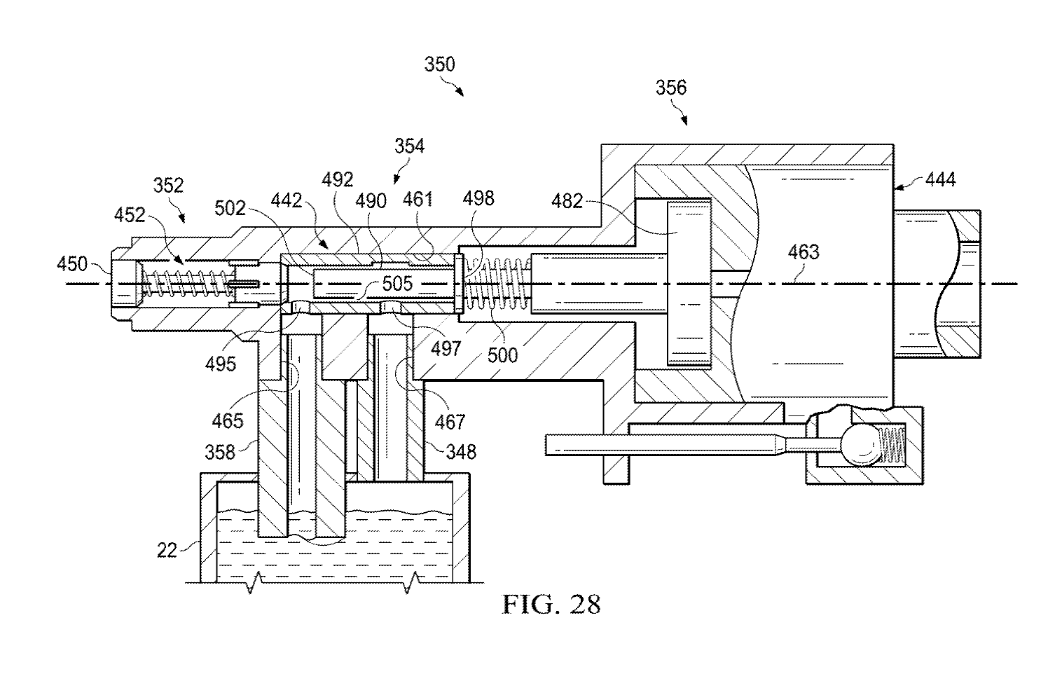

As shown in FIGS. 2 and 8-9, the lower ring 32 has a cylindrical side wall 112 centered on an axis 113. A circular end wall 114 reaches across the upper end of the side wall 112. Tubular portions 118 of the end wall 114 provide access passages for paint siphon and return tubes or lines (e.g., 358 and 348, respectively, discussed below with reference to FIG. 27) to reach through the lower ring 32 between the housing 16 and the paint container 22. A gasket 120 (FIG. 2) fits against an annular lower side surface 122 of the end wall 114, as shown in FIG. 10.

Four mounting bosses 130 on the end wall 114 are arranged in two pairs. The first pair of mounting bosses 130 have passages centered on a line 133 extending diametrically across the top of the end wall 114. The other pair of mounting bosses 130 have passages centered on offset lines 135 that are parallel to the diametrical line 133. Four arcuate slots 137 extend through the end wall 114. The slots 137 are arranged in a circular array centered on the axis 113, and are equally spaced apart from each other around the circumference of the end wall 114.

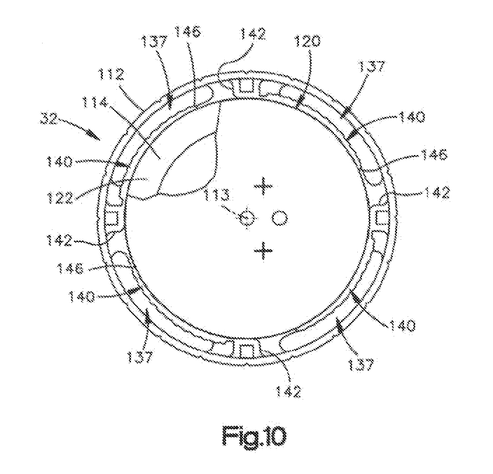

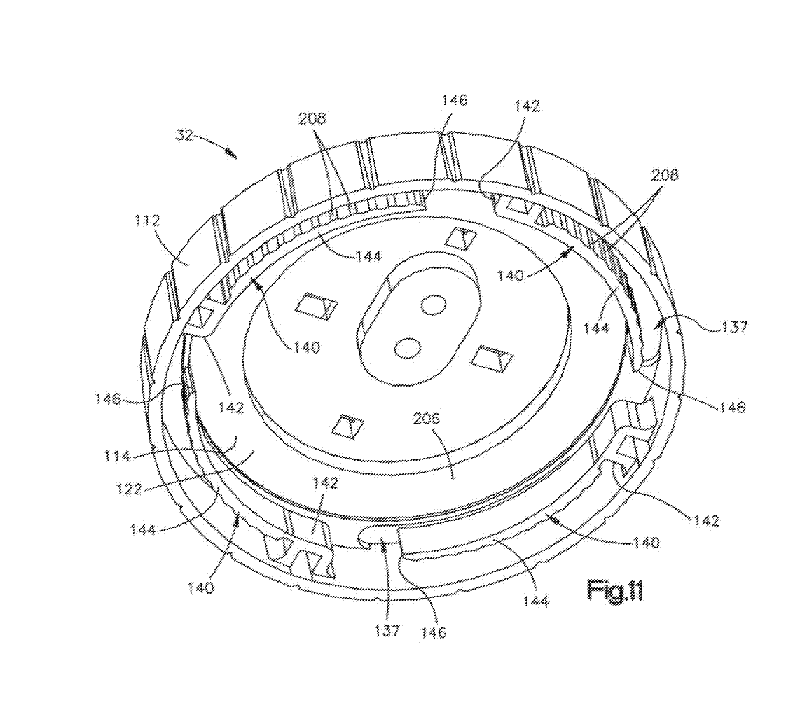

As shown in the bottom views of FIGS. 9-11, four grip members 140 are located on the lower ring 32 in a circular array beneath the four slots 137. In the preferred embodiment, the grip members 140 are alike, with each having a base 142 and an arm 144. Each base 142 projects radially inward from the side wall 112 between a pair of the slots 137. Each arm 144 projects from the respective base 142 to a free end 146. Specifically, each arm 144 has an elongated arcuate shape extending circumferentially alongside an adjacent slot 137. The length of each arm 144 reaches nearly to the opposite end of the slot 137. In this configuration, the arm 144 of each grip member 140 is pivotally deflectable radially about the base 142. Additionally, the thickness of each arm 144 decreases progressively along its length in a direction from the base 142 toward the free end 146, which is clockwise in the view of FIG. 9. This provides a space between the arm 140 and the side wall 112 that narrows progressively in the opposite direction, which is counterclockwise in FIG. 9.

The upper and lower rings 30 and 32 are supported on the handle 12 as shown in FIG. 1. When the side parts 40 and 42 are brought together to form the base portion 68 of the handle 12, each peg 50 on the right side part 40 is aligned with a corresponding peg 50 on the left side part 42. The outer end portions 54 of the pegs 50 are received in the mounting bosses 130 on the end wall 114 of the lower ring 32. The pegs 50 thus capture the end wall 114 within the handle base 68, and block the lower ring 32 from rotating relative to the handle 12.

The upper ring 30 is received coaxially over the base 68, with the wall 92 on the upper ring 30 overlaying the tapered side surface 70 of the base 68. The cams 100 on the upper ring 30 project downward through the slots 137 in the lower ring 32. As shown in FIG. 12, the cams 100 are received radially between the side wall 112 of the lower ring 32 and the arms 144 of the grip members 140. A closure ring 150 (FIG. 2) interconnects the cams 100 at their lower ends, and supports the lower ring 32 vertically beneath the upper ring 30.

The upper ring 30 is rotatable about the vertical axis 75 relative to the handle 12 and the lower ring 32. The cutout 99 provides a range of clearance for the wall 92 on the upper ring 30 to move circumferentially back and forth past the trigger guard 66. When the cams 100 on the upper ring 30 move circumferentially back and forth relative to the grip members 140, they cause the arms 144 of the grip members 140 to move radially back and forth. For example, when the cams 100 move counterclockwise in FIG. 12, they move farther into the progressively narrower spaces between the arms 144 and the side wall 112 of the lower ring 32. This causes the cams 100 to deflect the arms 144 radially inward from the side wall 112. Return movement of the cams 100 in the clockwise direction enables the arms 144 to deflect elastically back outward.

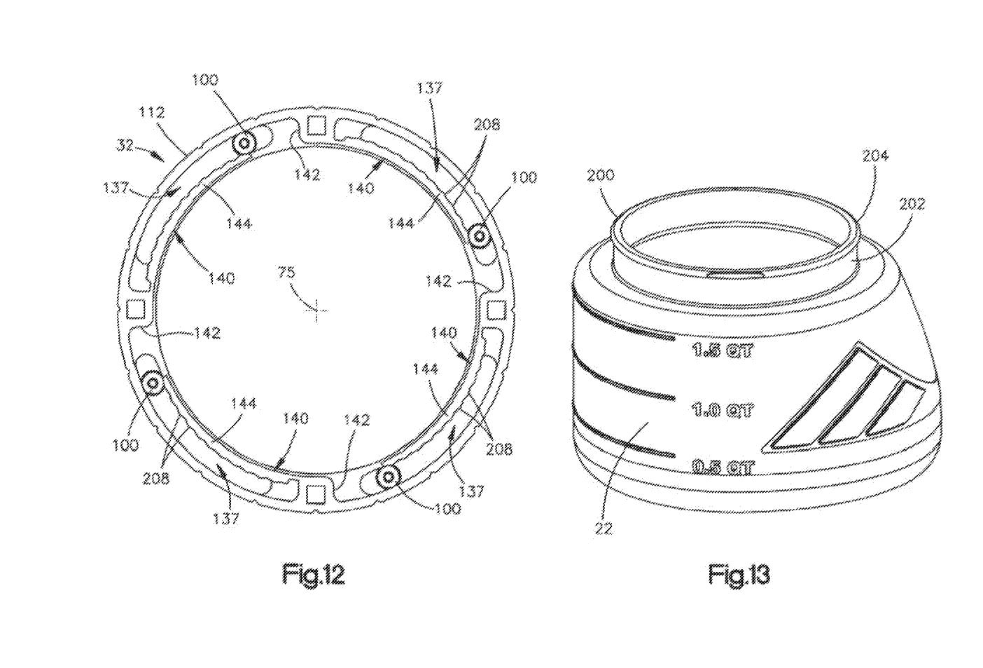

As shown separately in FIG. 13, the paint container 22 has a neck 200 with a cylindrical outer surface 202. A top rim 204 on the neck 200 projects a short distance radially outward from the outer surface 202. When the arms 144 of the grip members 140 have an initial, unstressed condition as shown in FIG. 12, their circular array has an inner diameter that is greater than the outer diameter of the top rim 204. This enables the paint container 22 to be moved axially into the lower ring 32 toward and into an installed position in which the top rim 204 abuts the gasket 120 beneath the lower ring 32. The upper ring 30 can then be rotated to deflect the arms 144 from the unstressed condition to a stressed condition in which the arms 144 reach radially inward beneath the top rim 204. The arms 144 then capture the neck 200 axially within the lower ring 32. Further rotation of the upper ring 30 can press the arms 144 firmly against the outer surface 202 of the neck 200. Ribs 208 on the arms 144 act as detents to hold the cams 100 in place, and may provide audible and tactile feedback to the user.

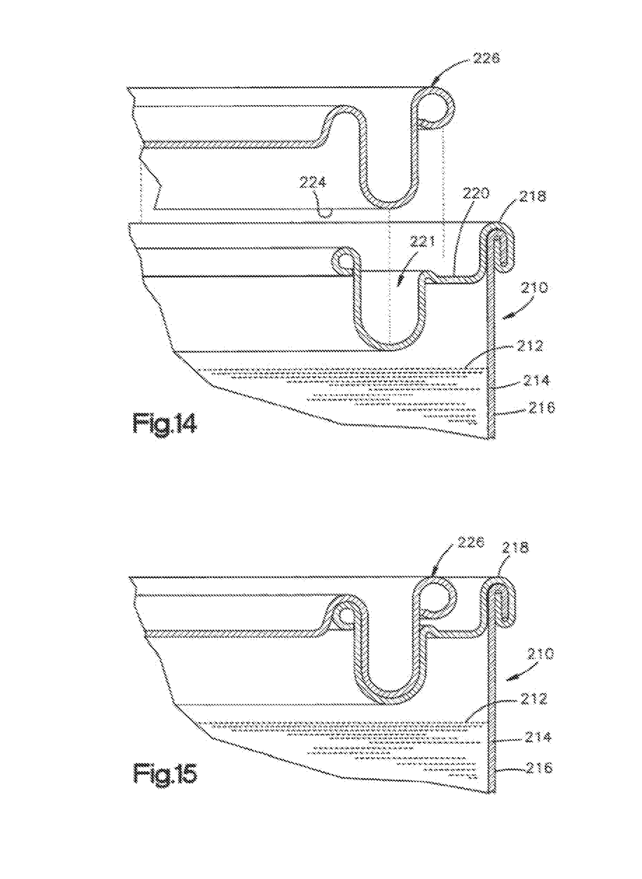

The paint sprayer 10 can also be used with an open can of paint instead of the paint container 22. As shown partially in FIGS. 14 and 15, such a can 210 of paint 212 typically has a side wall 214 with a cylindrical outer surface 216. A top rim 218 on the can 210 can be formed in part by the side wall 214 and in part by an inner rim 220. The inner rim 220 is shown to have a sealing groove 221 for receiving a sealing bead 224 on a paint can lid 226. Like the container 22, the can 210 is movable axially into the lower ring 32 to an installed position in which the top rim 218 abuts the gasket 120 beneath the lower ring 32. The open can 210 of paint 212 can be captured in that position by rotating the upper ring 32 to deflect the arms 144 radially inward beneath the top rim 218, and preferably by pressing the arms 144 radially inward against the outer surface 216 of the side wall 214. In one example, the can 210 can be a quart-sized container formed from metal and/or plastic.

It will be appreciated that, by using the paint sprayer with an open can of paint (e.g., 210) instead of the paint container 22, efficiencies can be achieved. For example, in such a configuration, an operator can set up the paint sprayer 10 for use by merely attaching the open can of paint to the paint sprayer 10, and need not pour paint from the can of paint into the paint container 22. After use, the operator can dispose of the can of paint when empty, or can replace the lid of the can of paint for storage. If the paint container 22 is not used, then the paint container 22 need not be cleaned after use of the paint sprayer 10, thereby saving an additional step.

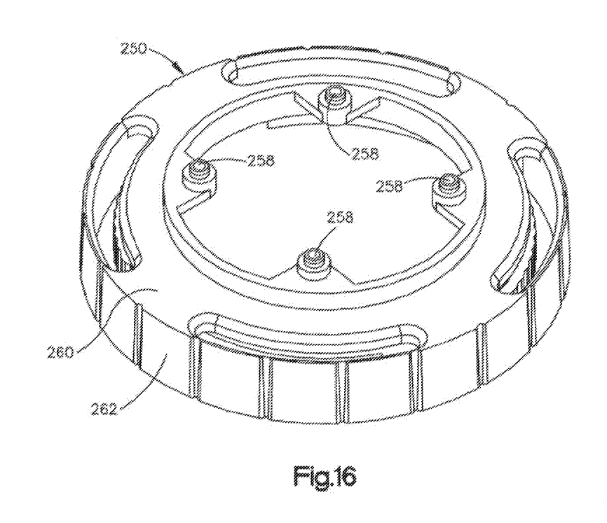

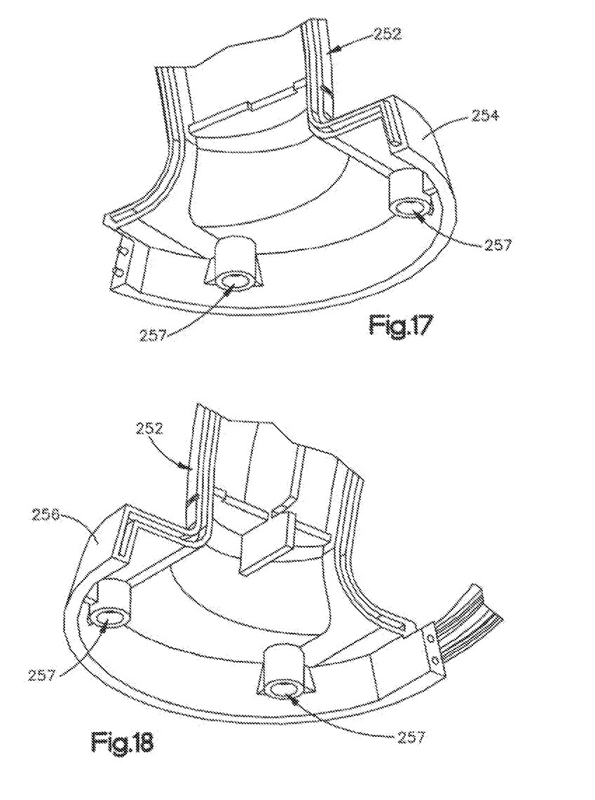

A second embodiment of the paint sprayer 10 has alternative parts shown in FIGS. 16-18, but is otherwise substantially the same as the first embodiment. These parts include a lower ring 250 and a housing 252 with left and right side parts 254 and 256. Each side part 254 and 256 of the housing 252 has a pair of bores 257 for receiving a corresponding pair of mounting bosses 258 on the lower ring 250. The mounting bosses 258 are located on an end wall 260 of the ring 250. Unlike the end wall 114 of the ring 32 described above, the end wall 260 of the ring 250 does not extend across the upper end of the respective side wall 262, but instead has an annular shape with an inner rim supporting the mounting bosses 258. The other parts of this ring 250 are substantially the same as the other parts of the ring 32 described above.

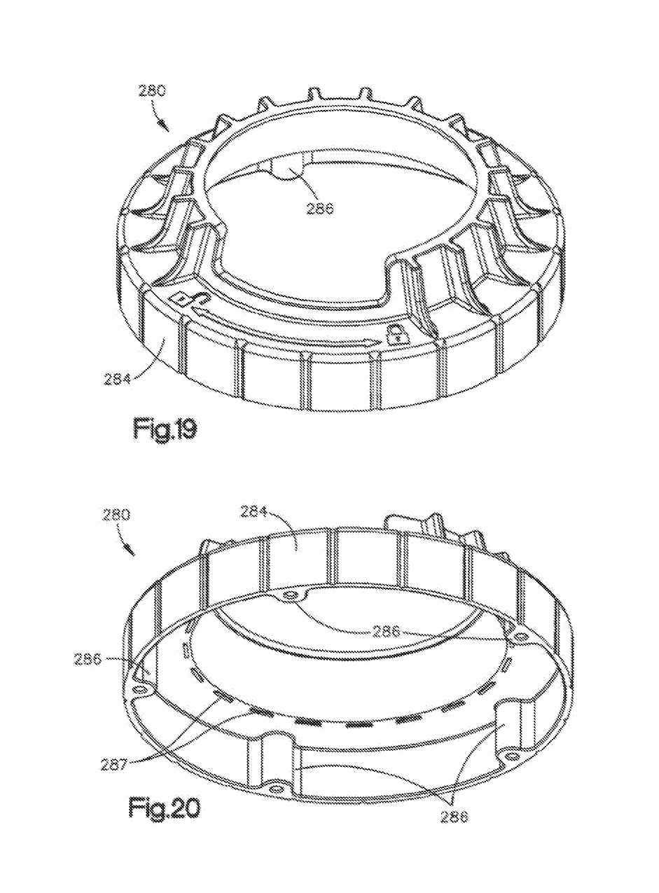

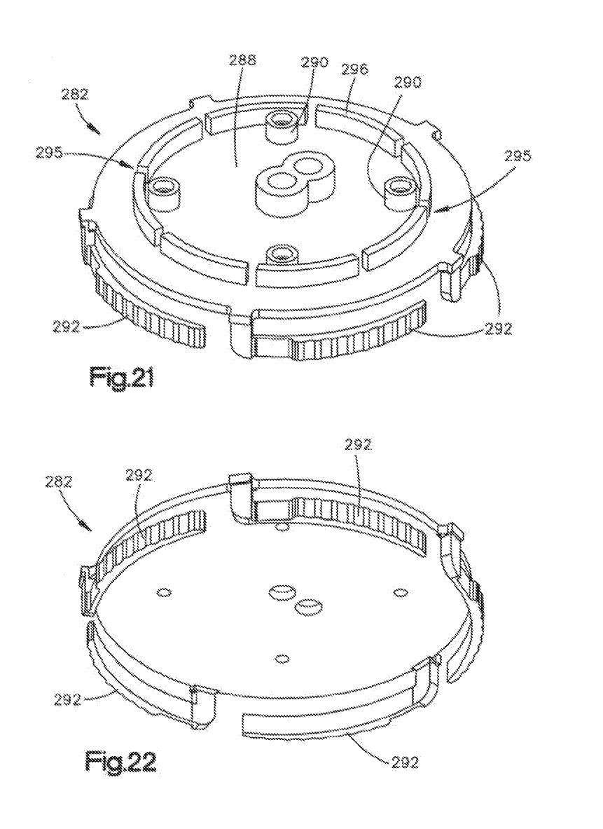

In a third embodiment, the paint sprayer 10 has the alternative upper and lower rings 280 and 282 shown in FIGS. 19-22. In this embodiment, the upper ring 280 has a side wall 284, whereas the other embodiments have side walls 112 and 262 on the lower rings 32 and 250. Cams 286 on the upper ring 280 adjoin the side wall 284. Ribs 287 at the underside of the upper ring 280 are spaced apart from each other in a circumferentially extending array.

The lower ring 282 in the third embodiment fits within the side wall 284 on the upper ring 280, and has an end wall 288 with mounting bosses 290 for securing to a housing. Grip members 292 on the lower ring 282, like the grip members 140 described above, secure a paint container in place under the influence of the cams 286. The lower ring 282 in the third embodiment further differs from the lower rings 32 and 250 in the first and second embodiments by having air flow slots 295 in a short cylindrical wall 296 atop the end wall 288.

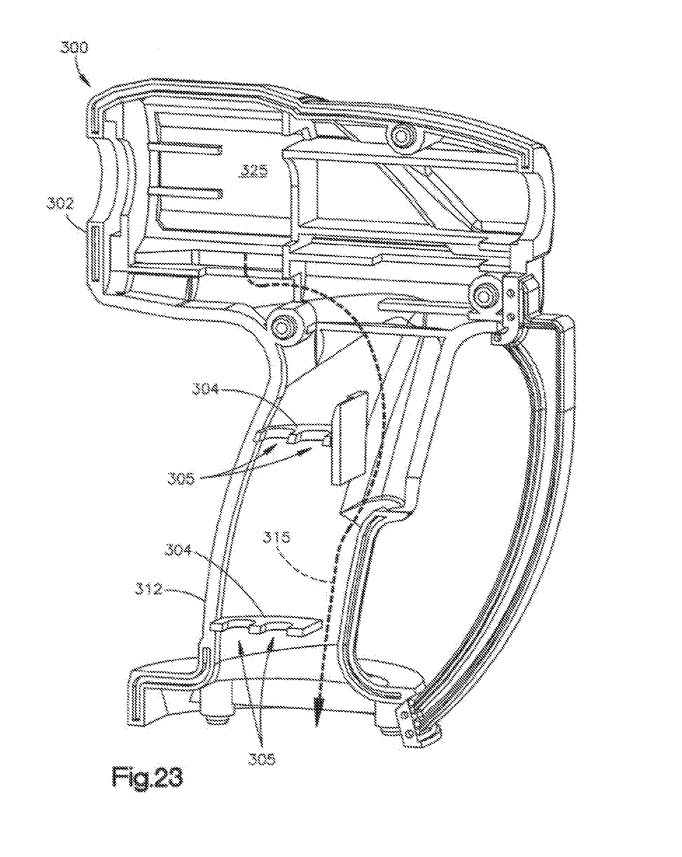

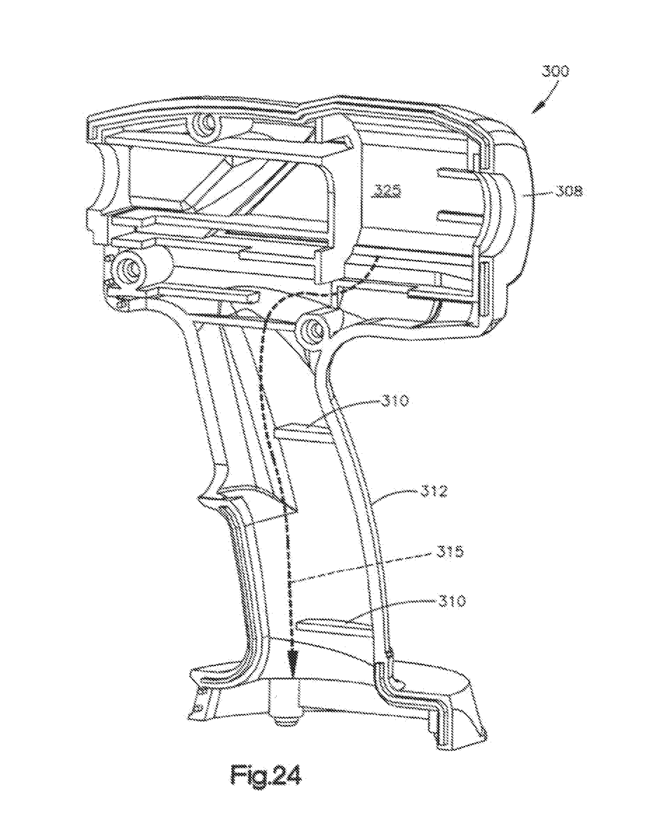

A housing 300 for the third embodiment of the paint sprayer 10 is shown in FIGS. 23 and 24. The left side part 302 (FIG. 23) of this housing 300 has internal ribs 304. Each rib 304 has a pair of notches 305 for receiving the paint siphon line 358 and the paint return line 348. Ribs 310 on the right side part 308 (FIG. 24) mate with the ribs 304 on the left side part 302 to capture the paint siphon line 358 and the paint return line 348 in the notches 305.

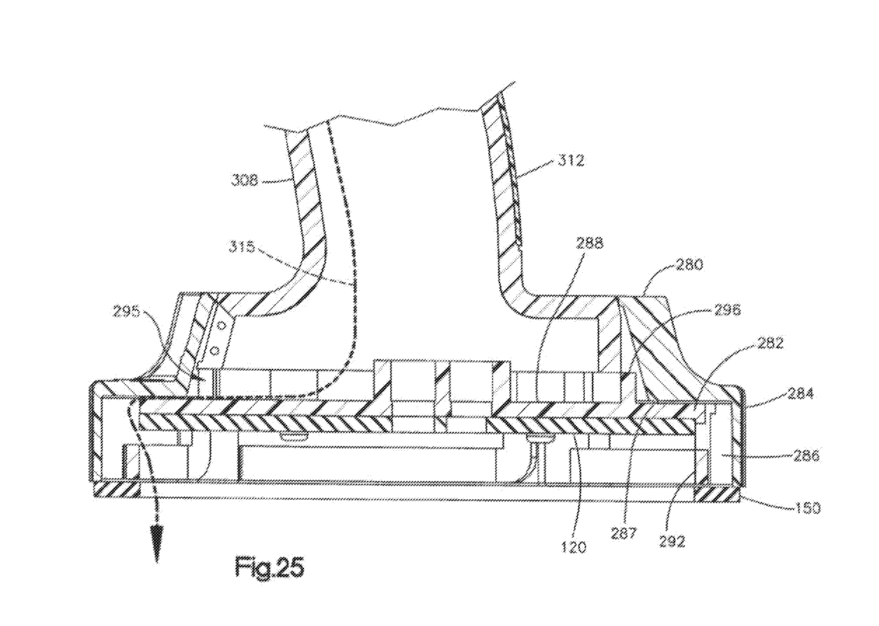

In one embodiment, the ribs 304 and 310 on the side parts 302 and 308 reach only partly across the handle portion 312 of the housing 300. This provides clearance for an air flow path 315, as shown in FIGS. 24-25. Specifically, the housing 300 has an air motor compartment 325 for containing an air motor. An air motor has one or more exhaust air vent holes (e.g., 359, described below). The internal walls and ribs of the housing side parts 302 and 308 together define the air flow path 315 for exhaust air to flow from the compartment 325 and downward through the handle 312 to the end wall 288 of the lower ring 282. As shown in FIG. 25, the slots 295 at the top of the lower ring 282 direct the exhaust air to flow radially outward toward the periphery of the end wall 288. The ribs 287 on the upper ring 280 overlie the end wall 288 of the lower ring 282 such that the spaces between the ends of the ribs 287 serve as slots through which the air flows further outward to the periphery of the end wall 288, from which it flows downward into the paint container.

FIG. 26 shows an air motor assembly 350 adapted for use with the housing 300 in the third embodiment. This air motor assembly 350 has a housing 352 with a front section 354 and a rear section 356. With further reference to FIG. 27, the front section 354 of the housing 352 contains a paint pump 442 that is in fluid communication with the nozzle 20. The paint pump 442 has a pump piston 490 for pumping paint upward through the paint siphon line 358 and outward through the nozzle 20 (FIG. 1). The rear section 356 contains an air motor 444 with a motor piston 482 that is coupled with the pump piston 490, so that the two pistons reciprocate together (in the same direction and distance) under the influence of pressurized air supplied to the air motor 444. In one embodiment, a set screw (not shown) can be provided to facilitate coupling of the motor piston 482 with the pump piston 490. Though, it will be appreciated that a motor piston can be coupled with a pump piston in any of a variety of other suitable configurations including, for example, use of other fasteners, other mechanical engagement, adhesives, welding, or formation as a unitary structure.

The rear section 356 of the housing 352 is received in the compartment 325 (FIGS. 23 and 24). A pair of circular exhaust air vent holes 359, one of which is shown in the side perspective view of FIG. 26, are located on opposite sides of the rear section 356 of the motor housing 352. A pair of air-permeable muffler structures 360 can be received over the vent holes 359. Each muffler structure 360, which is preferably formed of felt, is installed under compression between the outer surface of the rear section 356 and the surrounding inner surface of the adjacent side part 302 or 308 of the spray gun housing 300 inside the compartment 325. This helps to muffle the noise generated by exhaust air flowing outward from the vent holes 359.

In one embodiment, the air motor assembly 350 can be configured as shown in FIGS. 27-28. The paint siphon line 358 and the paint return line 348 can reach through the housing 16 vertically through the handle 12 between the paint container 22 and the air motor assembly 350. The air motor 444 can operate the paint pump 442 to draw paint upward from the container 22 through the paint siphon line 358, and to spray the paint outward through an atomizer assembly 450 which can be formed as part of, or coupled with, the nozzle 20. The paint siphon line 358 and the paint return line 348 can accordingly be provided in fluid communication with each of the paint pump 442 and the paint container coupling portion of the paint sprayer 10.

The front section 354 of the housing 352 is shown in FIGS. 27-28 to have a bore 461 centered on a longitudinal axis 463. The bore 461 is shown to contain the atomizer assembly 450 and the paint pump 442. A pair of passages 465 and 467 is the housing 352 can receive the paint siphon line 358 and the paint return line 348, respectively. The rear section 356 of the housing 350 defines a compartment 469 containing at least a portion of the air motor 444. A trigger valve assembly 470 is connected between the trigger 14 (FIG. 1) and the air motor 444, such as described below. Through operation of the trigger valve assembly 470, the trigger 14 can facilitate selective fluid communication between the air inlet port 18 and the air motor 444.

The air motor 444 can be fitted within the compartment 469, as described in further detail below. A portion of the motor piston 482 is shown to project from the compartment 469 into an air pressure chamber 483 in the air motor assembly 350, and can be supported for reciprocation in the air pressure chamber 483. The pump piston 490 can be supported for reciprocation in a paint flow space 505. The paint pump 442 further includes a sleeve 492. A pair of ports 495 and 497 in the sleeve 492 communicate with the passages 465 and 467, respectively. A seal 498 adjoins the sleeve 492. A spring 500 (shown schematically) is compressed axially between the seal 498 and the motor piston 482 to hold the seal 498 against the sleeve 492.

When the trigger valve assembly 70 is shifted open, the air motor 444 responds by reciprocating the motor piston 482 along the axis 463 under the influence of air pressure supplied at the air inlet port 18. As the motor piston 482 moves in a forward stroke toward the position of FIG. 27, a forward end 502 of the pump piston 490 drives paint forcefully through the atomizer assembly 450. The spring 500 assists the return stroke (FIG. 28) of the pump piston 490, which then develops a vacuum in the paint flow space 505 ahead of the forward end 502 of the pump piston 490, causing more paint to be drawn upward through the paint siphon line 358 into the paint flow space 505. In one embodiment, as shown, an outer diameter of the motor piston 482 can be greater than an outer diameter of the pump piston 490, which can facilitate generation of higher paint pressure at the atomizer assembly 450.

To prime the paint pump 442, motion of the pump piston 490 toward the atomizer assembly 450 can cause air caught between the forward end 502 and a check valve 452 to become compressed, until the pressure overcomes the check valve 452 and releases through the atomizer assembly 450. Motion of the pump piston 490 in the opposite direction (away from the atomizer assembly 450) can cause suction at the forward end 502, which pulls fluid up the paint siphon line 358. Once the fluid enters the paint flow space 505 from the paint siphon line 358, because the fluid is not compressible, motion of the pump piston 490 toward the atomizer assembly 450 can push the fluid from the paint flow space 505 through the check valve 452 and atomizer assembly 450.

Paint can accumulate in the paint flow space 505 between the pump piston 490 and the surrounding sleeve 492. For this reason, air from the air motor 444 can be allowed to leak past the seal 498 and into the paint pump 442 to drive accumulated paint through the adjacent port 497 in the sleeve 490 and further back to the container 22 through the paint return line 348.

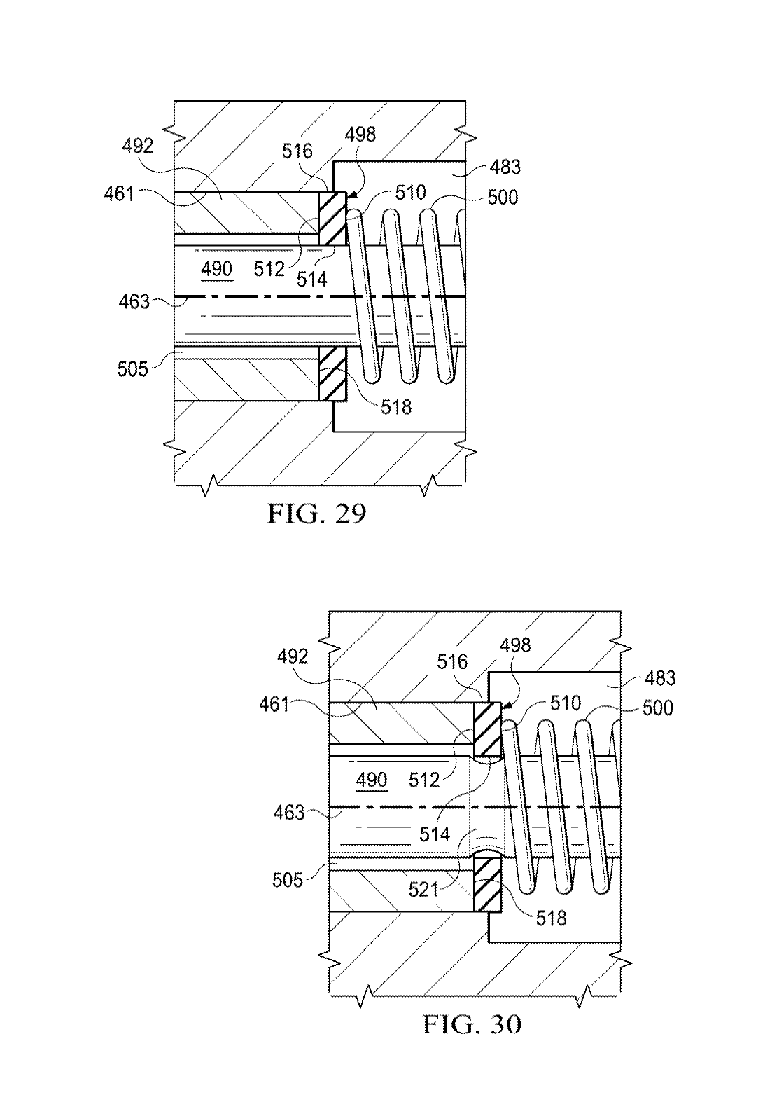

More specifically, the seal 498 can comprise a washer formed of an elastomer, such as a material sold under the trademark TEFLON. As shown in FIG. 29, the seal 498 has annular opposite side surfaces 510 and 512, a cylindrical inner surface 514, and a cylindrical outer surface 516. The spring 500 engages one side surface 510 of the seal 498 to press the other side surface 512 against an annular end surface 518 of the sleeve 492. The diameter of the seal 498 at the outer surface 516 matches the outer diameter of the sleeve 492, as well as the diameter of the bore 461 containing the sleeve 492, and the seal 498 is received partially within the bore 461. The inner surface 514 of the seal 498 engages the periphery of the pump piston 490. The spring 500 holds the seal 498 in place as the pump piston 490 reciprocates axially in sliding contact with the inner surface 514. The seal 498 is thus interposed between the paint flow space 505 in the paint pump 442 and the air pressure chamber 483 in the air motor 444. However, the seal 498 allows a small amount of air to escape from the air pressure chamber 483 between the inner surface 514 of the seal 498 and the periphery of the pump piston 490, into the paint flow space 505, during both forward and backward movement of the motor piston 482 and the pump piston 490. This serves to allow air to flow from the air pressure chamber 483 to the paint flow space 505, to drive paint back into the container 22 through the paint return line 348. This also serves to provide a positive pressure and helps to block paint from flowing past the seal 498 from the paint flow space 505 to the air pressure chamber 483. By blocking paint from flowing from the paint flow space 505 to the air pressure chamber 483, paint typically cannot enter the air pressure chamber 483 during normal use of the paint sprayer 10, thus making it simpler to clean the paint sprayer 10 after use (e.g., by requiring only little, or no, disassembly of the paint sprayer 10 to facilitate its cleaning).

Air that leaks from the air motor 444 into the paint pump 442 can flow through the paint return line 348 and into the container 22, to slightly pressurize the container 22 to assist the flow of paint upward from the container 22 through the paint siphon line 358. Additionally or alternatively, regardless of whether a paint return line 348 is provided, a portion of the exhaust air from the air motor 444 which flows from the compartment 325 and downward through the handle 312 along the air flow path 315 (FIGS. 24-25), can slightly pressurize the container 22 to assist the flow of paint upward from the container 22 through the paint siphon line 358. As a result of air entering the container 22 through the paint return line 348 and/or the air flow path 315, the air pressure in the container 22 can reach about 3 psi above atmospheric pressure, for example, which can be helpful for moving heavy paint (e.g., latex paint) up to and through the paint pump 442, where suction alone may not be sufficiently effective. In such a configuration, the container 22 can be free of a vent to the atmosphere, as shown schematically in FIGS. 27-28. Vents in paint containers of conventional paint sprayers can easily become clogged, which can be irritating and time consuming to resolve. In other embodiments, however, it will be appreciated that a paint sprayer can facilitate venting of a container to the atmosphere.

In the alternative embodiment shown in FIG. 30, the pump piston 490 is provided with a groove 521 that reaches circumferentially around the periphery of the piston 490. The groove 521 is wider than the inner surface 514 of the seal 498. When the piston 490 reaches the terminal forward stroke position of FIGS. 27 and 30, the groove 521 adjoins the inner surface 514 to provide an air flow past the seal 498 and into the paint flow space 505.

The air motor 444 can be provided in any of a variety of suitable configurations. For example, as illustrated in FIGS. 35-38, the air motor 444 can include a backing plate 602, a rear valve seat 604, a middle valve seat 606, a front valve seat 608, a valve chest 610, a cylinder end plate 612, and a piston housing 614. The rear valve seat 604, the middle valve seat 606, the front valve seat 608, the valve chest 610, the cylinder end plate 612, and the piston housing 614 are shown to be sandwiched between the backing plate 602 and a front wall 616 of the housing 352. As will be described in further detail below, the rear valve seat 604, the middle valve seat 606, the front valve seat 608, the valve chest 610, the cylinder end plate 612, and the piston housing 614 can cooperate together to route pressurized air from the backing plate 602 to the motor piston 482 to facilitate actuation of the motor piston 482.

As illustrated in FIGS. 37 and 38, the rear valve seat 604 can include a front surface 618 (FIG. 37) and a rear surface 620 (FIG. 38) and can define a passageway 622. The passageway 622 can extend into an elongated recess 624 defined by the front surface 618 such that the passageway 622 and the elongated recess 624 are in fluid communication with one another. The rear valve seat 604 can include a trigger support portion 626 that defines a trigger receptacle 628 that extends into the elongated recess 624 such that the trigger receptacle 628 and the elongated recess 624 are in fluid communication with one another. With the backing plate 602 and the rear valve seat 604 sandwiched together, as illustrated in FIG. 35, the passageway 622 can be in fluid communication with an outlet port 630 (FIG. 37) defined by the backing plate 602. The outlet port 630 can be in fluid communication with the air inlet port 18.

Referring again to FIGS. 37 and 38, the middle valve seat 606 can include a front surface 632 (FIG. 37) and a rear surface 634 (FIG. 38). The middle valve seat 606 can include a trigger support portion 635 that defines a trigger passageway 636 that can extend into, and can be in fluid communication with, an elongated recesses 638 defined by the front surface 632.

The front valve seat 608 can include a front surface 640 (FIG. 37) and a rear surface 642 (FIG. 38) and can define a central bore 644, a passageway 646, and two outer perimeter passageways 648. The front valve seat 608 can include a trigger support portion 650 that defines a trigger passageway 652 that can extend into, and can be in fluid communication with, an elongated recess 654 defined by the rear surface 642. As illustrated in FIG. 38, each of the outer perimeter passageways 648 can extend into, and can be in fluid communication with, respective elongated recesses 656 defined by the rear surface 642. Each of the elongated recesses 656 can extend from the respective outer perimeter passageways 648 and to the central bore 644. With the middle and front valve seats 606, 608 sandwiched together, as illustrated in FIG. 35, the respective elongated recesses 638, 654 can be in fluid communication with one another. The front surface 632 of the middle valve seat 606 can cover the central bore 644, the outer perimeter passageways 648, and the elongated recesses 656.

Referring again to FIGS. 37 and 38 and additionally to FIGS. 39 and 40, the valve chest 610 can include a front surface 664 (FIG. 37) and a rear surface 666 (FIG. 38). The valve chest 610 can define a pair of passageways 668 and two outer perimeter passageways 670. The front surface 664 can define a front recess 672. As illustrated in FIG. 40, the passageways 668 can extend into a ring recess 674 defined by the rear surface 666. As illustrated in FIGS. 39 and 40, the valve chest 610 can define a central bore 676 and inner perimeter passageways 678 that extend through the front recess 672. The valve chest 610 can include an inner shoulder portion 680 and an outer shoulder portion 682 disposed within the front recess 672. The inner perimeter passageways 678 can be disposed circumferentially about the central bore 676 such that they are disposed radially inwardly from the outer shoulder portion 682 and radially outwardly from the inner shoulder portion 680. As illustrated in FIG. 40, the inner perimeter passageways 678 can extend into, and can be in fluid communication with, respective elongated recesses 684 defined by the valve chest 610. The elongated recesses 684 can extend into, and can be in fluid communication with, the ring recess 674. With the front valve seat 608 and the valve chest 610 sandwiched together, as illustrated in FIG. 35, the outer perimeter passageways 648 of the front valve seat 608 can each be in fluid communication with one of the respective outer perimeter passageways 670 of the valve chest 610. The passageway 646 of the front valve seat 608 can be in fluid communication with the ring recess 674 and thus in fluid communication with the inner perimeter passageways 678 by way of the elongated recesses 684. The central bore 644 of the front valve seat 608 can be in fluid communication with the central bore 676 of the valve chest 610.

Referring again to FIGS. 37 and 38 and additionally to FIG. 41, the cylinder end plate 612 can include a front surface 686 and a rear surface 688. The cylinder end plate 612 can define a central bore 690 and two outer perimeter passageways 692. As illustrated in FIG. 41, the rear surface 688 of the cylinder end plate 612 can define a recess 694. An inner shoulder 696 can extend from the recess 694 and can define one end of the central bore 690. The inner shoulder 696 can include an upper surface 698 that is substantially coplanar with the rear surface 688.

As illustrated in FIGS. 37 and 38, a flapper 802 can be provided between the valve chest 610 and the cylinder end plate 612. With the valve chest 610 and the cylinder end plate 612 sandwiched together, as illustrated in FIG. 35, the flapper 802 can be disposed within the front recess 672 of the valve chest 610. In addition, the outer perimeter passageways 670 of the valve chest 610 can each be in fluid communication with respective ones of the outer perimeter passageways 692 of the cylinder end plate 612.

The piston housing 614 can define two outer perimeter passageways 804 and can be formed as a generally annular ring having a pair of planar side portions 806. A vent 808 can be defined at each respective planar side portion 806. With the cylinder end plate 612 and the piston housing 614 sandwiched together, as illustrated in FIG. 35, the outer perimeter passageways 692 of the cylinder end plate 612 can each be in fluid communication with respective ones of the outer perimeter passageways 804 of the piston housing 614. A gasket 810 can be sandwiched between the cylinder end plate 612 and the piston housing 614 and can define through holes 812 and a central bore 814 that are arranged to permit passage of fluid between the cylinder end plate 612 and the piston housing 614. Another gasket 815 can be sandwiched between the piston housing 614 and the front wall 616 of the housing 352.

Referring again to FIGS. 37 and 38, the housing 352 can have the front wall 616 and a side wall 816 that cooperate to define the compartment 469. As illustrated in FIG. 35, each of the rear valve seat 604, the middle valve seat 606, the front valve seat 608, the valve chest 610, the cylinder end plate 612, and the piston housing 614 can be disposed within the compartment 469 of the housing 352 and can be sandwiched between the front wall 616 and the backing plate 602. The backing plate 602 can be threaded to the side wall 816 of the housing 352 to restrain the rear valve seat 604, the middle valve seat 606, the front valve seat 608, the valve chest 610, the cylinder end plate 612 and the piston housing 614 within the compartment 469 of the housing 352. In other embodiments, the backing plate 602 can be secured to the housing 352 with a circlip, frictional engagement, welding, or any of a variety of suitable alternative securement methods.

As illustrated in FIGS. 37 and 38, the air motor 444 is shown to include an alignment pin 822 which projects through respective alignment holes 823, 824, 825, 826, 827, 828 of the middle valve seat 606, the front valve seat 608, the valve chest 610, the cylinder end plate 612, the gasket 810, and the piston housing 614 to facilitate proper alignment for assembly of the air motor 444. As illustrated in FIG. 37, the rear valve seat 602 can define an alignment recess 829. As illustrated in FIG. 42, the front wall 616 of the housing 352 can define an alignment aperture 832. Each of the alignment recess 829 and the alignment aperture 832 can receive respective ends of the alignment pin 822 when the air motor 444 is assembled.

As will be appreciated with reference to FIGS. 35-38, the respective trigger support portions 626, 635, and 650 of the rear, middle, and front valve seats 604, 606, and 608 can cooperate to help support the trigger valve assembly 470. The trigger valve assembly 470 is shown to include a trigger stem 660 and a spring 662. The trigger stem 660 can include a ball-shaped valve portion 658 that is disposed within the trigger receptacle 628 and biased with respect to the trigger support portion 626 by the spring 662. The trigger stem 660 can extend through the respective passageways 636, 652 of the middle and front valve seats 606, 608 such that it is accessible for actuation by an operator. The spring 662 can bias the ball-shaped valve portion 658, and thus the trigger stem 660, into a released position (shown in FIG. 35). In this position, the ball-shaped valve portion 658 can rest against the trigger support portion 635 of the middle valve seat 606 to block pressurized air from the back plate 602 from operating the air motor 444. Further operation of the trigger valve assembly 470 will be described in further detail below.

When a pressurized source of air is connected to the air inlet port 18, the backing plate 602 can route the pressurized air through the outlet port 630 and through the passageway 622 of the rear valve plate 604. The pressurized air travels along the elongated recess 624, and to the ball-shaped valve portion 658 of the trigger stem 660. With the trigger stem 660 in the released position (shown in FIG. 35), the ball-shaped valve portion 658 can block the pressurized air from operating the air motor 444. When the trigger stem 660 is actuated (by an operator's depression of the trigger 14), the ball-shaped valve portion 658 can be moved away from the trigger support portion 635 of the middle valve seat 606 such that pressurized air can flow through the backing plate 602, the rear valve seat 604, the middle valve seat 606, the front valve seat 608, the valve chest 610, the cylinder end plate 612, and the piston housing 614 in a manner that facilitates reciprocation of the motor piston 482. When the trigger stem 660 is depressed (not shown) and the ball-shaped valve portion 658 moves away from the trigger support portion 635 of the middle valve seat 606, the pressurized air can be routed through the trigger passageway 636 of the middle valve seat 606, through the respective elongated recesses 638, 654 of the middle and front valve seats 606, 608, through the passageway 646 of the front valve seat 608, to the ring recess 674 of the valve chest 610, and to each of the passageways 668 and the inner perimeter passageways 678 of the valve chest 610. A sealing member, such as an O-ring, can be provided at the trigger passageway 652 to prevent pressurized air from escaping through the trigger passageway 652.

As illustrated in FIG. 35, with the motor piston 482 in a home or rearward position, the flapper 802 rests against the inner and outer shoulders 680, 682 (e.g., in a rearward position) to block the pressurized air at the inner perimeter passageways 678. The pressurized air accordingly flows through the passageways 668, to the recess 694 of the cylinder end plate 612, between the cylinder end plate 612 and the flapper 802, through the central bore 690, through the gasket 810, and acts upon a rear surface 834 (FIG. 38) of the motor piston 482 to move the motor piston 482 forwardly.

Once the motor piston 482 reaches its forward or extended position, as illustrated in FIG. 36, the pressurized air acting upon the rear surface 834 of the motor piston 482 escapes through the vents 808 in the piston housing 614 and through vent holes 359 defined by the side wall 816, as illustrated in FIG. 42. The pressurized air no longer acts upon a rear surface 834 of the motor piston 482 and as a result, the pressurized air through the inner perimeter passageways 678 of the valve chest 610 increases enough, relative to the pressurized air through passageways 668, to urge the flapper 802 forwardly and into contact with the upper surface 698 of the inner shoulder 696 of the cylinder end plate 612, as illustrated in FIG. 36. The pressurized air is accordingly prevented from flowing through the central bore 690 of the cylinder end plate 612 and is instead routed rearwardly (e.g., towards the backing plate 602) through the central bore 676 of the valve chest 610 and through the central bore 644 of the front valve seat 608. The pressurized air is then routed down the elongated recesses 656, through the respective outer perimeter passageways 648, 670, and 692 of the front valve seat 608, the valve chest 610, and the cylinder end plate 612, through the through holes 812 of the gasket 810 and through the outer perimeter passageways 804 of the piston housing 614. As illustrated in FIG. 42, two elongated recesses (e.g., 836) can be defined by the front wall 616 of the housing 352. These elongated recesses (e.g., 836) can route the pressurized air from the outer perimeter passageways 648, 670, and 692 to a front surface 838 (FIG. 37) of the motor piston 482 to move the motor piston 482 rearwardly.

Once the motor piston 482 reaches its home or rearward position, the pressurized air through the passageways 668 of the valve chest 610 increases enough, relative to the pressurized air through the inner perimeter passageways 678, to urge the flapper 802 rearwardly and into contact with each of the inner and outer shoulders 680, 682 thereby urging the motor piston 482 forwardly again. The pressurized air can repeatedly and alternatively act upon the respective front and rear surfaces 838, 834 of the motor piston 482 to facilitate reciprocation of the motor piston 482 during operation of the paint sprayer 10. The flapper 802 and associated components of the air motor 444 can accordingly provide a flapper valve arrangement that facilitates reciprocation of both the motor piston 482 and the pump piston 490 in response to pressurized air received at the air inlet 18 port. It will be appreciated that a linear-type air motor, such as air motor 444, can work more efficiently (i.e., by consuming less air) than a conventional rotary-type air motor.

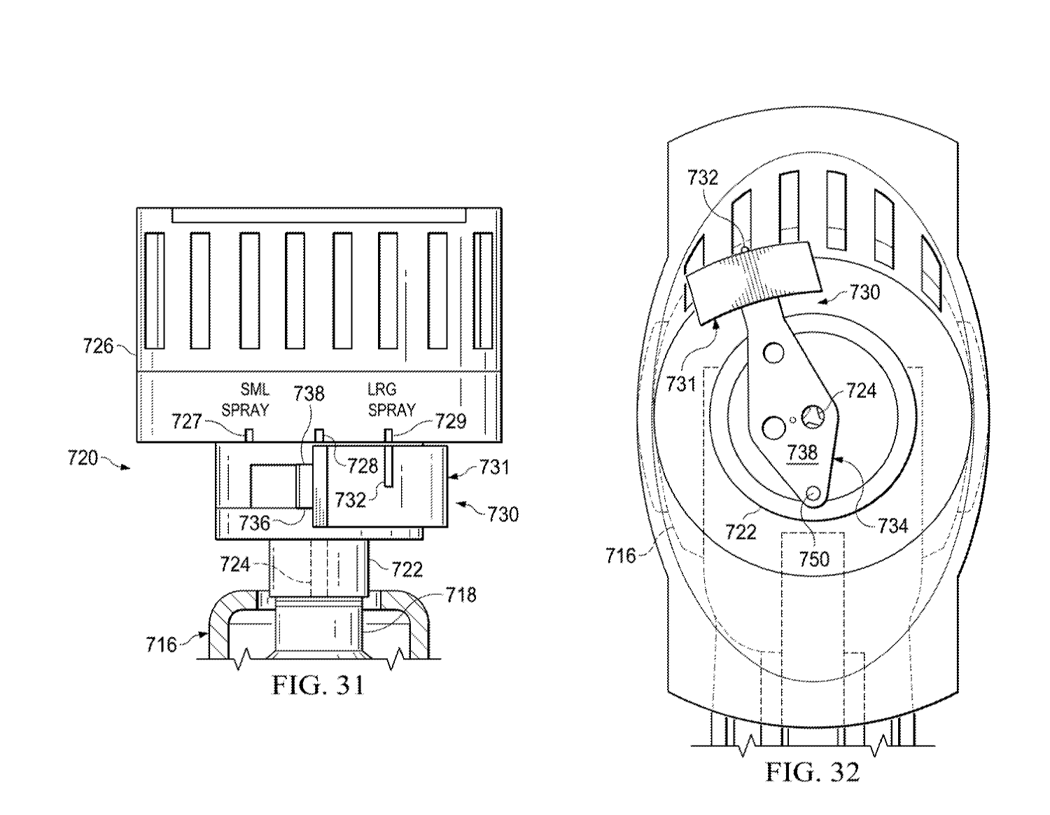

In one embodiment, the nozzle of a paint sprayer can be adjustable to facilitate selection from among a plurality of different spray patterns and/or sizes. For example, such a nozzle can comprise a nozzle assembly 720 as shown in FIG. 31. The nozzle assembly 720 can include an inlet structure 722, a spray head 726, and a selector switch. The inlet structure 722 is shown to be attached (e.g., via threading) to an outlet 718 supported by a housing 716 of the paint sprayer. The outlet 718 can be part of, or coupled with, a paint pump of the paint sprayer. The inlet structure 722 is shown in FIGS. 31-32 to define a fluid entry passageway 724 that can be provided in fluid communication with the paint pump.

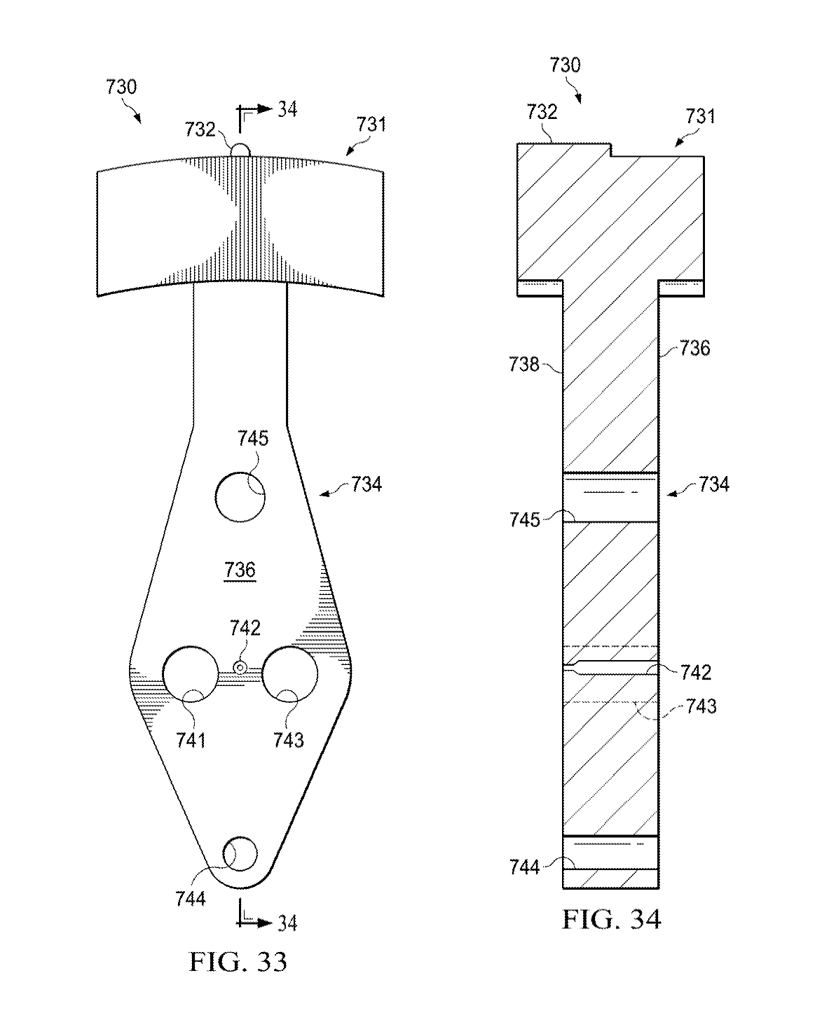

The selector switch can include a lever 730 having a finger interface portion 731 and a valve portion 734. In one embodiment, the finger interface portion 731 and the valve portion 734 can be formed as a unitary structure, such as from plastic, metal or otherwise, as shown in FIGS. 33-34. In an alternative embodiment, a lever of a selector switch can be formed from multiple separate components that are attached together.

A lever of a selector switch can be movable among at least two positions, such as by pivoting. Though, it will be appreciated that a lever might be configured to move among positions in a manner other than pivoting. In the example of FIGS. 31-34, the lever 730 can pivot among a first position, a second position, and a third position. The finger interface portion 731 be configured for contact by an operator's finger to facilitate movement of the lever 730 among the available positions.

In the respective first, second and third positions, an indicator 732 of the finger interface portion 731 can align with a respective indicator 727, 728 and 729 provided on the spray head 726, in order that an operator of the nozzle assembly 720 can easily visually identify the selected position. Words or symbols might also be provided to facilitate identification of the selected position to the operator.

The valve portion 734 of the lever 730 can comprise opposite side walls 736 and 738 that extend parallel with one other, and can define a plurality of apertures 741, 742, 743 that extend entirely through the valve portion 734. Each of the apertures 741, 742, and 743 can correspond with a respective one of the selectable positions of the lever 730. It will be appreciated that, depending upon the position of the lever 730, a respective one of the apertures 741, 742 and 743 can align with the fluid entry passageway 724. More particularly, when the lever 730 in in a first position, the fluid entry passageway 724 can be aligned (e.g., coaxially aligned) and in fluid communication with the aperture 741, but not in fluid communication with either of the other apertures 742 or 743. When the lever 730 in in a second position, the fluid entry passageway 724 can be aligned (e.g., coaxially aligned) and in fluid communication with the aperture 742, but not in fluid communication with either of the other apertures 741 or 743. When the lever 730 in in a third position, the fluid entry passageway 724 can be aligned (e.g., coaxially aligned) and in fluid communication with the aperture 743, but not in fluid communication with either of the other apertures 741 or 742. In one embodiment, the apertures 741, 742, and 743 can be parallel with one another, and with the fluid entry passageway 724.

In one example, the nozzle assembly 720 can include a pivot pin 750 (FIG. 32) that facilitates pivotal coupling of the lever 730 relative to the inlet structure 722. The valve portion 734 can define an aperture 744 that receives at least a portion of the pivot pin 750. A detent (not shown), such as a ball and spring detent, can be partially received within an aperture 745 defined by the valve portion 734 of the lever, and configured to frictionally engage the inlet structure 722 and/or the spray head 726 to facilitate selective maintenance of the lever 730 in a desired one of the first, second and third positions. Each of the apertures 744 and 745 can extend partially or completely through the valve portion 734 of the lever 730. In one embodiment, each of the apertures 744 and 745 can be parallel with the fluid entry passageway 724. It will be appreciated that a lever can be pivotally or otherwise moveably coupled with respect to an inlet structure in any of a variety of other suitable configurations.

It will be appreciated that each of the apertures 741, 742, and 743 can have a different size and/or shape such that, depending upon which of the apertures 741, 742 and 743 is aligned with the fluid entry passageway 724, the orifice and resulting spray pattern of the nozzle assembly 720 can be changed (e.g., among a round spray pattern, a medium fan spray pattern, and a large fan spray pattern). Selection of the orifice and resulting spray pattern of the nozzle assembly 720 can accordingly be accomplished by mere movement of the lever 730 among the available positions. The size and/or shape of the orifice provided by the nozzle assembly 720 can affect the pressure and flow rate of the paint, fluid or other material being sprayed. An operator can thus spray different paints or other fluids or materials with differing thixotropy and/or other characteristics, and/or to achieve different flow or application rates or patterns, by mere movement of the lever 730, and without requiring removal or replacement of the nozzle assembly 720 or other components of the paint sprayer.

The nozzle of a paint sprayer can be provided in any of a variety of other suitable configurations to be adjustable to facilitate selection from among a plurality of different spray patterns and/or sizes. One such other configuration is illustrated In FIG. 43 as nozzle assembly 920. Nozzle assembly 920 can be generally similar to nozzle assembly 720, except that nozzle assembly 920 can include a ring or wheel portion 933 that can be rotated by an operator relative to an inlet structure 922 and a spray head portion 926 of the nozzle assembly 920. Rotation of the wheel portion 933 can result in movement of an actuator portion of a lever 930 of the nozzle assembly 920, and resultant movement of a valve portion 934 of the lever 930, to facilitate selection from among a plurality of different spray patterns and orifices. A resilient member 931 or other structure(s) can be provided to facilitate coupling of the wheel portion 933 with the actuator portion of the lever 930.

It will be appreciated that the paint sprayer 10 can be used for application of any of a variety of paints such as, for example, latex-based, oil-based and alcohol-based paints. It will also be appreciated that the paint sprayer 10 can be used for application of fluids or materials other than paints such as, for example, water, food products, lubricants, other coatings, or otherwise. The paint sprayer 10 can be quieter, lighter in weight, have less vibration, and/or facilitate better atomization and spray quality, and/or be suitable for use with a wider range of sprayed fluid(s) or material(s), as compared with conventional devices.

It will also be appreciated that the foregoing features can be provided in any of a variety of suitable alternative configurations. For example, in one alternative embodiment, a paint sprayer having a paint container coupling portion configured for attaching to an open can of paint, and/or certain other features described herein, might not include a linear-type air motor (e.g., air motor 444) but might rather include a rotary-type air motor or even an electric motor.

While various embodiments have been illustrated by the foregoing description and have been described in considerable detail, it is not intended to restrict or in any way limit the scope of the appended claims to such detail. Additional modifications will be readily apparent to those skilled in the art.

1-32. (canceled)

33. A paint sprayer assembly comprising:
a housing defining an air motor compartment;
a paint container configured for selective coupling with the housing;
a nozzle supported by the housing;
an air inlet supported by the housing;
a paint siphon line; and
an air motor assembly disposed at least partially within the air motor compartment, the air motor assembly comprising an air motor and a paint pump coupled with the air motor, the air motor coupled with the air inlet and defining an exhaust air vent hole, and the paint pump in fluid communication with the nozzle and the paint siphon line such that the paint pump is configured to siphon paint from the paint container, through the paint siphon line, and outward through the nozzle;
wherein the housing defines an air flow path extending from the exhaust air vent hole to the paint container, to facilitate pressurization of the paint container by air exhausted by the air motor.

34. The paint sprayer assembly of claim 33 wherein:
the housing comprises a handle portion;
the air flow path extends through the handle portion; and
the paint siphon line extends through the handle portion.

35. The paint sprayer assembly of claim 34 wherein the housing comprises a left side part and a right side part.

36. The paint sprayer of assembly claim 35 wherein the left side part and the right side part cooperate to form the handle portion and define the air motor compartment.

37. The paint sprayer assembly of claim 36 further comprising a paint return line in fluid communication with the paint pump and configured to facilitate return of paint from the paint pump to the paint container.

38. The paint sprayer assembly of claim 37 wherein at least one of the left side part and the right side part comprises an internal rib of the handle portion, the internal rib defines a pair of notches, and the pair of notches receives the paint siphon line and the paint return line.

39. The paint sprayer assembly of claim 38 wherein the left side part cooperates with the right side part to define a portion of the air flow path.

40. The paint sprayer assembly of claim 33 wherein:
the air motor comprises a motor piston;
the paint pump comprises a pump piston;
the motor piston is coupled with the pump piston such that the motor piston and the pump piston are configured to reciprocate together under the influence of pressurized air received at the air inlet.

41. The paint sprayer assembly of claim 33 further comprising an air-permeable muffler structure, wherein the housing further defines a housing vent hole, the air-permeable muffler structure is disposed between the exhaust air vent hole and the housing vent hole, and the air-permeable muffler structure is configured to muffle noise generated by exhaust air flowing outwardly from the exhaust air vent hole.

42. The paint sprayer assembly of claim 41 wherein the air-permeable muffler structure is formed of felt.

43. The paint sprayer assembly of claim 34 wherein the housing portion further comprises an upper ring and a lower ring, the upper ring comprises ribs, the lower ring comprises an end wall, the ribs on the upper ring overlie the end wall of the lower ring such that spaces between the ends of the ribs serve as slots through which exhaust air flows outwardly to the periphery of the end wall, from which it flows downward into the paint container.

44. An apparatus comprising:
a paint container;
a paint pump with a pump piston supported for reciprocation in a paint flow space;
a paint siphon line and a paint return line communicating the paint container with the paint flow space;
an air motor with a motor piston that is supported for reciprocation in a pressurized air chamber, the motor piston being coupled with the pump piston; and
seal means for blocking paint from flowing from the paint flow space to the pressurized air chamber, and for allowing air to flow from the pressurized air chamber to the paint flow space.

45. An apparatus as defined in claim 44 wherein the seal means comprises a piston seal with a first side exposed to the paint flow space and a second side exposed to the pressurized air chamber.

46. An apparatus as defined in claim 44 wherein the piston seal consists of a ring-shaped structure having planar opposite side surfaces, an annular outer surface, and an annular inner surface in sliding engagement with the pump piston.

47. An apparatus as defined in claim 46 wherein the piston seal consists of a washer.

48. An apparatus as defined in claim 44 wherein the pump piston has a peripheral air flow recess that adjoins the seal means when the pump piston is in a terminal forward stroke position.

49. An apparatus as defined in claim 48 wherein the peripheral air flow recess is a groove reaching around the pump piston.

50-74. (canceled)

75. A paint sprayer comprising:
a housing defining an air motor compartment, a pistol grip handle, and a paint container coupling portion;
an air inlet supported by the housing;
an air motor assembly disposed at least partially within the air motor compartment, the air motor assembly comprising an air motor and a paint pump coupled with the air motor;
a trigger supported by the pistol grip handle and configured to facilitate selective fluid communication between the air inlet and the air motor;
a paint siphon line extending through the pistol grip handle and in fluid communication with each of the paint container coupling portion and the paint pump; and
a nozzle supported by the housing and in fluid communication with the paint pump.

76. The paint sprayer of claim 75 wherein:
the air motor comprises a motor piston;
the paint pump comprises a pump piston;
the motor piston is coupled with the pump piston such that the motor piston and the pump piston are configured to reciprocate together under the influence of pressurized air received at the air inlet.

77. The paint sprayer of claim 76 wherein the motor piston and the pump piston are configured to reciprocate in the same direction and distance.

78. The paint sprayer of claim 77 wherein an outer diameter of the motor piston is greater than an outer diameter of the pump piston.

79. The paint sprayer of claim 78 wherein the air motor comprises a flapper valve configured to facilitate reciprocation of the motor piston in response to pressurized air received at the air inlet.

80. The paint sprayer of claim 76 wherein the air motor comprises means for facilitating reciprocation of the pump piston.
